(19) United States
(12) Patent Application Publication
(10) Pub. No.: US 2017/0140645 A1
(43) Pub. Date: May 18, 2017

(54) Traffic monitoring system

(71) Applicant: The Board of Regents of the University of Oklahoma, Norman, OK (US)

(72) Inventors: Walid Balid, Tulsa, OK (US); Hazem Refai, Tulsa, OK (US)

(21) Appl. No.: 15/330,823

(22) Filed: Nov. 7, 2016

Related U.S. Application Data
(60) Provisional application No. 62/251,992, filed on Nov. 6, 2015.

(51) Int. Cl. G08G 1/01; G08G 1/042; G08G 1/052; G08G 1/015

(52) U.S. Cl. CPC G08G 1/0116; G08G 1/015; G08G 1/042; G08G 1/052; H04W 4/008

(57) ABSTRACT

An automated computerized system comprises a computer system executing traffic monitoring software. The traffic monitoring software reads data corresponding to a magnetic field of a first vehicle collected by a first node. The traffic monitoring software may determine a unique magnetic signature for the first vehicle from the data collected by the first node, and correlate the first vehicle using the magnetic signature to a predefined vehicle class. The predefined vehicle class may group vehicles by structural similarity.

### CROSS-REFERENCE TO RELATED APPLICATION(S)

The present application claims the benefit of U.S. Ser. No. 62/251,992, filed Nov. 6, 2015, which is hereby incorporated by reference in its entirety.

### BACKGROUND

An ever-growing population places increasing demands on transportation systems. The Federal Highway Administration (FHWA) estimates an average 1.04% annual growth in vehicle miles travelled (VMT) over the next 20 years [1]. This represents a 23% increase in VMT by 2032. Notwithstanding, the nation's transportation agencies have been concerned with traffic safety over the last two decades, which is expected to intensify as VMT increases. A vast number of studies and strategic plans have focused on exploring new solutions and developing innovative methods to increase roadway safety and efficiency nationwide.

Statistical studies by The National Highway Traffic Safety Administration (NHTSA) reported 2.3 million injuries and 32,719 fatalities in 2013 [2]. Traffic fatalities are the leading cause of death for people between age 4-27 [3]. A new NHTSA study estimates direct economic cost and societal impact of vehicular accidents on U.S. roadways is $871 billion per year, resulting from an average 5.8 million crashes. This number represents 1.9% of the $14.96 trillion gross domestic product (GDP) reported in 2010 [4]. According to [5], traffic congestion causes annual expenditures of $121 billion to the nation's economy. More than 5.5 billion lost hours in congested traffic results in 2.9 billion gallons fuel waste each year. About 31% (or 56 billion pounds) of carbon dioxide are emitted from vehicle tailpipes each year [6].

To prevent worsening levels of congestion, the U.S. government would have to expand current transportation system infrastructure capacity by 23%. One option is increasing the number of lane miles, which translates to 4,200 miles of new roadway each year [7]. Another option is developing alternate routes with the aid of intelligent transportation systems (ITSs) designed to maximize capacity and improve existing infrastructure efficiency. ITSs are an integral part of nationwide traffic management systems (TMS). ITSs performance depends substantially on accuracy of reported data and spatial distribution of traffic sensors [8].

Vehicle detection and surveillance are an integral part of ITSs. Both functions are subject to continuous improvement toward enhancing vehicle presence detection and counting, monitoring headway and speed, and classifying vehicles. Traffic detection and volume prediction methods are dependent upon a number of factors, including current and historic traffic measurements. Widely used vehicle detection technologies can be classified into three groups: intrusive, non-intrusive, and off-roadway sensors. Intrusive sensors include inductive loops, magnetic detectors, pneumatic road tubes, piezoelectric, and weight-in-motion sensors. These technologies are embedded in the road surface after saw-cutting the surface or adding roadway holes. Non-intrusive sensors include vision systems, microwave radar, and infrared and ultrasonic detectors. These technologies can be installed atop roadway or roadside surfaces or mounted overhead. Off-roadway sensors, such as remote sensing via aircraft or satellite and probe vehicles equipped with GPS receiver, do not require installation on roadways. A description of these technologies can be found in [7], [9].

Both intrusive and non-intrusive sensors are power-hungry, expensive, and have been known to cause installation difficulties. They typically require wired infrastructures and power lines for energy supply. Other drawbacks of intrusive sensors include large-sized, short life—as short as 48 h for tubes [10], and high maintenance cost, which require lane closure and traffic disruption. Resurfacing or repairing the roadway may also require the sensors to be reinstalled. Moreover, safety aspect of workers deploying these systems has been a major concern [10]. Although vision systems and radars are usually accurate and do not disrupt traffic, their performance is subject to weather conditions (e.g. fog, rain, snow, or wind). Off-roadway sensors provide limited traffic statistics at fixed location and limited coverage, subject to the number of probe vehicles [7], [9]. Consequently, these sensors are inadequate for large-scale integration or temporary installation; they are deployed only at critical locations and work independently of each other.

Wireless sensor networks (WSNs) are emerging as a promising technology and a key enabler for an enormous number of physical-world sensing applications not previously possible (e.g., Internet-of-things) [11]. Applications of WSNs are ubiquitous because of their exceptional features, such as flexibility, cost effectiveness, and simple installation [12]. Moreover, WSNs are favored for their power efficiency, reliability of data delivery, and scalability. The last of these features is important for WSN ITSs, particularly as systems are able to accommodate an increased number of nodes connected in an ad-hoc, self-configurable manner [13]. A comprehensive survey of the WSNs for ITS applications can be found in [12]. Systems employing WSN consist of medium to large networks of inexpensive wireless nodes capable of sensing, processing, and collaboratively distributing data acquired from the physical-world [11]. WSNs have been integrated with various state-of-the-art embedded smart sensors, such as magnetometers and accelerometers, managed by sophisticated algorithms that enable autonomous methods of real-time traffic surveillance applications [14]-[16].

There have been a number of different methods using various types of electronic sensors for traffic monitoring. One approach recently proposed in literature is using wireless magnetometer sensors [16]-[28]. The use of magnetic sensors for vehicle detection can be traced to 1978 [29] when a fluxgate magnetic sensor was used to actuate a lighting system from the magnetic fields of passing vehicles. The essential principle in this method is that vehicles' chassis have significant amounts of ferrous materials (e.g., iron, steel, nickel, or cobalt) that cause local disturbance in the Earth's magnetic field, which can be measured using a magnetic sensor.

Magnetometer sensors are an alternative to inductive loops. They are sensitive, inexpensive, small in size, and weigh little. Additionally, unlike traditional technologies, magnetometers are immune to poor weather conditions, don't require line-of-sight, and have a longer life [30]. Integrating a magnetometer sensor with WSN can serve in various traffic monitoring applications. For example, a study in [16] analyzed the performance of using magnetic sensors for vehicle detection and classification in stop-and-go scenarios. System assessment reported 6% error in counting and 9% in classification. Authors in [17] reported a detection accuracy of 99.05% in low-speed congested traffic using a fixed-threshold state machine algorithm and three-axis anisotropic magnetoresistive sensor (AMR). Another study [18] proposed using a two-axis magnetometer sensor for detecting vehicle driving direction. A high detection rate of 99% was observed when vehicles on the lane pass too closely to the sensor. Performance degraded to 89% as the SNR decreased. A wireless link budget study for intersection monitoring using magnetometer sensor was proposed in [19]. A speed estimation algorithm using magnetic sensors is proposed in [20], [21]. In this work, cross-correlation is applied to calculate delay between signals from two aligned roadside sensors at a pre-defined distance. Although this method achieved relatively accurate estimates, it proved computationally expensive, hence energy inefficient. A two-threshold, four-state machine algorithm is proposed in [22] for vehicle detection using 3-axis AMR sensor. Work proposed in [23] integrated IEEE 802.15.4 transceiver with 32-bit MCU and 1-axis AMR for vehicle counting and collision warning application. Authors in [24] used a 3-axis AMR sensor for vehicle detection in parking lots. Vehicle classification and detection using an improved support vector machine (ISVM) classifier was proposed in [25]. A single-axis magnetic sensor was employed. The proposed algorithm was tested using 93 vehicles classified into only three classes—heavy tracked, tracked, and light-wheeled, instead of the 13 classes defined by FHWA [31]. Reported recognition rate was 90%. An active magnetic detection method was introduced in [26]. Although this method solved the baseline drift problem, it was not efficient in power, cost, or size. Authors in [27] proposed a detection and classification approach using a state machine detection algorithm, a shared adaptive threshold to compensate background noise, and a neuron classifier. A two-axis AMR sensor was employed. A 90% recognition rate was reported for simulation and on-road testing. Authors in [28] proposed a short-time transform detection and recognition algorithm using a magnetic sensor sampled at 2 KHz. Lastly, in addition to aforementioned platforms, a number of commercial platforms based-on magnetometers are also currently available [32]-[34].

In the aforementioned solutions, a magnetic sensor was mainly used to detect vehicles, and a standardized wireless protocol (e.g., IEEE 802.15.4) was considered for node-to-node and node-to-AP communications. Nevertheless, in most of these solutions, sensors must be embedded in roadway lanes. Although the time required for installing a few systems [32]-[34] into the pavement is comparatively small, these systems are relatively expensive, intrusive, and cannot be used for temporary studies or portable traffic monitoring applications (e.g., work zone safety, roadway design studies, and managing traffic in emergency situations, like evacuations, among others). Although a variety of detection methods have been proposed, limited evaluation has been performed to measure detection accuracy per vehicle class over a full range of speed. A single method fails to encompass variances between different magnetic characteristics.

### BRIEF DESCRIPTION OF THE DRAWINGS

Several embodiments of the present disclosure are hereby illustrated in the appended drawings. It is to be noted however, that the appended drawings only illustrate several typical embodiments and are therefore not intended to be considered limiting of the scope of the present disclosure. Further, in the appended drawings, like or identical reference numerals or letters may be used to identify common or similar elements, and not all such elements may be so numbered. The figures are not necessarily to scale, and certain features and certain views of the figures may be shown as exaggerated in scale or in schematic in the interest of clarity and conciseness. Various dimensions shown in the figures are not limited to those shown therein and are only intended to be exemplary.

FIG. 1 is a schematic diagram of an exemplary traffic monitoring system of the present disclosure.

FIG. 2A is a block diagram of an exemplary node for use in the traffic monitoring system of the present disclosure.

FIG. 2B is a schematic diagram of an exemplary node illustrated in FIG. 2A positioned on a PCB board.

FIG. 3A is a block diagram of an exemplary atmospheric sensing module for use in the traffic monitoring system of the present disclosure.

FIG. 3B is a schematic diagram of an exemplary node illustrated in FIG. 3A positioned on a PCB board.

FIG. 4A is a block diagram of another version of an exemplary node for use in the traffic monitoring system of the present disclosure.

FIG. 4B is a schematic diagram of an exemplary node illustrated in FIG. 4A positioned on a PCB board.

FIG. 5 is a block diagram of an exemplary power system and data intercommunication between on-board functional components for use in the exemplary node illustrated in FIG. 4.

FIG. 6 is a block diagram of hierarchical integration of hardware and software of an exemplary node for use in the traffic monitoring system of the present disclosure.

FIG. 7 is a schematic diagram illustrating the impact of passing vehicle on the Earth's magnetic flux at a plurality of detection points.

FIG. 8 is a graphical representation of detection algorithm parameters applied to a vehicle flux magnitude for use in the present disclosure.

FIG. 9 is a functional block diagram for an exemplary vehicle detection and counting algorithm of the present disclosure.

FIG. 10 is a block diagram of an exemplary state machine process for vehicle detection and counting for the present disclosure.

FIG. 11 is a flowchart of an exemplary process for adaptive compensation of geomagnetic baseline drift for the present disclosure.

FIG. 12 is schematic diagram of an exemplary deployment setup for a plurality of nodes for speed estimation.

FIGS. 13 and 14 are block diagrams of exemplary RTC drift correction systems for the present disclosure.

FIG. 15 illustrates a flow chart representation of RTC frequency drift compensation using GPS-PPS signal.

FIG. 16 is a schematic diagram of an exemplary Length Based Vehicle Classification (LBVC) schemes for the present disclosure.

FIG. 17 is a table of length boundaries for use in the LBVC system of FIG. 14.

FIG. 18 is an Implementation model for LBVC Scheme for the present disclosure.

FIG. 19 is a schematic diagram of detection zone edges for the present disclosure.

FIG. 20 is a flow chart of exemplary re-identification methods for identifying similarities in signals between downstream and upstream nodes.

FIG. 21 is a schematic diagram of a media control access (MAC) identification system for use in the traffic monitoring system of the present disclosure.

### DETAILED DESCRIPTION

The present disclosure describes a non-intrusive, inexpensive, and portable real-time vehicular traffic monitoring system (hereinafter “system”) for either permanent or temporary installment on the surface of a path including, but not limited to, highways, roadways, roadsides, sidewalks, driveways, gates, or parking lots. In some embodiments, the system includes a plurality of nodes having sensors that are comprised of solid-state electronics to detect, count, estimate speed and length, and classify and re-identify vehicles, eliminating inherent limitations when using vehicle sensors including hoses extending across the path or inductive loops impeded in roads. The utilization of the system can be extended to improve work zone safety, in general, by reducing installation time and providing real-time traffic monitoring. The system can be utilized in various applications and studies (e.g., traffic flow studies, and work zone safety, intersection capacity, traffic light automation, and bridges and highway design) or exclusively for traffic management in atypical situations such as population evacuation.

Before describing various embodiments of the present disclosure in more detail by way of exemplary descriptions, examples, and results, it is to be understood that the embodiments of the present disclosure are not limited in application to the details of systems, methods, and compositions as set forth in the following description. The embodiments of the present disclosure are capable of other embodiments or of being practiced or carried out in various ways. As such, the language used herein is intended to be given the broadest possible scope and meaning; and the embodiments are meant to be exemplary, not exhaustive. Also, it is to be understood that the phraseology and terminology employed herein is for the purpose of description and should not be regarded as limiting unless otherwise indicated as so. Moreover, in the following detailed description, numerous specific details are set forth in order to provide a more thorough understanding of the disclosure. However, it will be apparent to a person having ordinary skill in the art that the embodiments of the present disclosure may be practiced without these specific details. In other instances, features which are well known to persons of ordinary skill in the art have not been described in detail to avoid unnecessary complication of the description.

Unless otherwise defined herein, scientific and technical terms used in connection with the embodiments of the present disclosure shall have the meanings that are commonly understood by those having ordinary skill in the art. Further, unless otherwise required by context, singular terms shall include pluralities and plural terms shall include the singular.

All patents, published patent applications, and non-patent publications referenced in any portion of this application are herein expressly incorporated by reference in their entirety to the same extent as if each individual patent or publication was specifically and individually indicated to be incorporated by reference.

As utilized in accordance with the concepts of the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims and/or the specification is used to mean “and/or” unless explicitly indicated to refer to alternatives only or when the alternatives are mutually exclusive, although the disclosure supports a definition that refers to only alternatives and “and/or.” The use of the term “at least one” will be understood to include one as well as any quantity more than one, including but not limited to 2, 3, 4, 5, 6, 7, 8, 9, 10, 15, 20, 30, 40, 50, 100, or any integer inclusive therein. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y, and Z.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

Throughout this application, the term “about” is used to indicate that a value includes the inherent variation of error that exists among the study subjects. Further, in this detailed description, each numerical value (e.g., temperature or time) should be read once as modified by the term “about” (unless already expressly so modified), and then read again as not so modified unless otherwise indicated in context. Also, any range listed or described herein is intended to include, implicitly or explicitly, any number within the range, particularly all integers, including the end points, and is to be considered as having been so stated. For example, “a range from 1 to 10” is to be read as indicating each possible number, particularly integers, along the continuum between about 1 and about 10. Thus, even if specific data points within the range, or even no data points within the range, are explicitly identified or specifically referred to, it is to be understood that any data points within the range are to be considered to have been specified, and that the inventors possessed knowledge of the entire range and the points within the range. Further, an embodiment having a feature characterized by the range does not have to be achieved for every value in the range, but can be achieved for just a subset of the range. For example, where a range covers units 1-10, the feature specified by the range could be achieved for only units 4-6 in a particular embodiment.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

Compared to other solutions, the disclosed system is portable, non-intrusive, cost effective, and accurate, providing reliable and real-time traffic data collection. The system can be configured to detect traffic direction and count vehicles in moving-state over a full range of speeds in urban-roads and highways; steady-state in parking lots, or/and for stop-and-go scenarios at traffic lights or intersections. Vehicle speed and length can be estimated using two time-synchronized nodes. Estimated cost of a single node is relatively very low. In some embodiments, system auto-configurability, over-the-air programmability, and scalability are facilitated by an RF engine with IEEE 802.15.4 protocol. The platform can be installed on the surface of roadways or roadsides using a suitable bonding material, such as an adhesive, that may reduce both deployment and maintenance costs. Roadway deployment may be more convenient than other systems for multi-lane highways, although more useful for urban-roads. Adjacent lane effect is also discussed herein.

Another use for this system is atypical situations where traffic management over unplanned evacuation path may be extremely important to facilitate localized traffic management for smooth population evacuation. Intelligent parking lot management is another application for the disclosed system. The system can be used to manage the parking lot by reporting the occupant/vacant parking spots and their locations. Automatic garage door, automatic gates, drive thru vehicle detector, ramp metering, travel time estimation, traffic data collection, intersection capacity, collision avoidance, and highway design are all applications that may include uses with the embodiments of the presently disclosed system.

In the literature, studies proposed either fixed [20] or adaptive [27] threshold detection algorithms. Adaptive algorithms are used to keep detection threshold above a reference level that could drift due to variations in temperature, background noise, vibrations, aging, or relative earth magnetic field over time. The present disclosure uses, in at least one embodiment, a multi-threshold-based detection algorithm as discussed below. Drift in geomagnetic baseline threshold is adaptively auto-calibrated in real-time. This method may aid in solving problems reported in [17] by keeping magnetic signal variation at a minimum; hence, provide a reliable estimation of vehicle speed in low-speed congested traffic, as well as at high speeds.

Unlike other platforms, the sampling rate in an exemplary embodiment of the disclosed system is not fixed and can be configured according to a particular application. For example, low sampling rate is useful for detection and counting applications. High sampling rate is useful for vehicle recognition based-on magnetic signature. Controlling sampling rate has significant implication on reducing power consumption and increasing the system's lifetime. Power consumption can be significantly reduced by configuring the system to automatically transition to a higher sampling rate when needed (e.g., detection of vehicle arrival).

The embodiments of the present disclosure, having now been generally described, will be more readily understood by reference to the following examples and embodiments, which are included merely for purposes of illustration of certain aspects and embodiments of the present disclosure, and are not intended to be limiting. The following detailed examples of systems and/or methods of use of the embodiments of the present disclosure are to be construed, as noted above, only as illustrative, and not as limitations of the disclosure in any way whatsoever. Those skilled in the art will promptly recognize appropriate variations from the various structures, components, procedures, and methods.

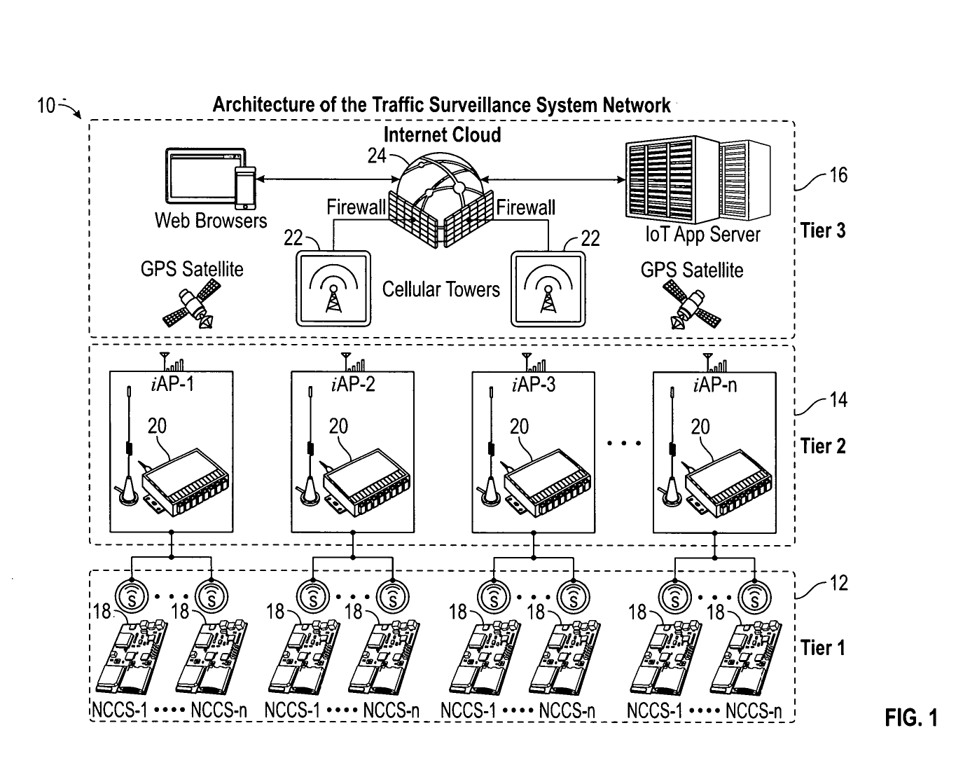

Referring to the Figures, and in particular to FIG. 1, illustrated therein is an exemplary traffic monitoring system 10 constructed in accordance with the present disclosure. Generally, the traffic monitoring system 10 may include three tiers, 12, 14 and 16, respectively. The first tier 12 includes one or more nodes 18. Although FIG. 1 illustrates eight nodes 18 within the first tier 12, it should be noted that any number of nodes 18 may be used within the traffic monitoring system 10. Each node 18 may include an embedded radio frequency (RF) module and a unique identifier (ID). In some embodiments, the unique ID may be reported with positional coordination for mapping purposes.

The second tier 14 includes one or more intelligent access points 20 (iAPs). Any number of iAPs may be used. For example, each iAP may manage up to a predetermined number of nodes 18 (e.g., 12 nodes 18). Although pairs of nodes 18 are shown communicating with the iAPs, it should be noted that individual nodes 18 may communicate with iAPs. Additionally, three or more nodes 18 may communicate with each iAP 20.

Generally, each iAP 20 may include a transceiver and communication system. The iAP may be selected to facilitate connection timing to maximize traffic savings and minimize communication cost. For example, in some embodiments, the iAP may include a long-range ZigBee transceiver and an embedded industrial general packet radio service (GPRS) module. However, any transceiver and/or communication system configured to receive and/or communicate data according to the disclosure herein may be used including Bluetooth, Wi-Fi, LTE, Z-wave, LoRaWAN, Dash7, and WirelessHeart. Data may be accessed via dynamic name system (DNS), Internet Protocol address (IP address), and/or the like. For example, networking between the nodes 18 and the iAPs 20, in some embodiments, may be facilitated trough an IEE 802.15.4 protocol with ZigBee on top.

Generally, upon startup of each node 18, a multicast remote procedure call (RPC) may be sent to inquire about the address of one or more iAPs 20 for managing a channel and network. The iAP 20 may respond to the RPC by sending an address to the originating node 18. In the event that the iAP 20 fails to send a response after a predetermined number of inquiries within a predetermined amount of time, the node 18 may switch to an offline mode. If a connection is established, the node 18 may switch to an online mode wherein data may be exchanged with the iAP 20 upon request. Data received by the iAP 20 may be processed, analyzed, and/or logged onto a local memory.

Once connection is established between the node 18 and the iAP 20, the node 18 may exchange data with the iAP 20. In some embodiments, such requests may be managed by serial inquiry frames and commands. For example, the iAP 20 may use Inquiry Frame “IQF” to send an inquiry to either specified node(s) 18 requesting information (e.g., battery health, memory status; number of counted vehicles, time, date, sensor status, raw data, temperature, and/or the like). The corresponding node 18 may respond with Inquiry Response Frame “IQRF.” iAPs 20 may also use Command Frame “CMDF” to send one or more commands to one or more nodes 18 asking for a specific task to be executed by the node 18 (e.g., configure magnetometer, conduct recalibration). The corresponding node 18 may respond with a Command Confirmation Frame “CCF” to confirm the task by writing a binary value “101010”, for example, in the CMD byte or deny the request by writing the binary value “010101”, for example.

The iAP 20 may communicate data to the third tier 16. Communication of data may be over a network. The network may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a satellite network, a radio network, an optical network, a cable network, a public switched telephone network, an Ethernet network, combinations thereof, and/or the like. Additionally, the network may use a variety of network protocols to permit bi-directional interface and/or communication of data and/or information. It is conceivable that in the near future, embodiments of the present disclosure may use more advanced networking topologies. In one non-limiting example, iAPs 20 may communicate with the third tier 16 over a cellular network 22 as illustrated in FIG. 1. In some embodiments, the communication over the cellular network 22 may be assisted by a Quad-Band GSM/GPRS chipset with an on-board GPS module.

Data, such as processed data form the iAPs 20, may be transmitted from the iAPs 20 to a server 24, such as an IoT cloud server. In some embodiments, the iAPs 20 may transmit the data continuously to the server 24. Alternatively, the iAPs 20 may store the data for a predetermined time prior to transmitting the data to the server 24. In some embodiments, the iAPs 20 may transmit the data when requested by the server 24.

In some embodiments, the server 24 may manage and/or control network configurations for the system 10. Additionally, in some embodiments, the server 24 may facilitate firmware upgrades for the system 10.

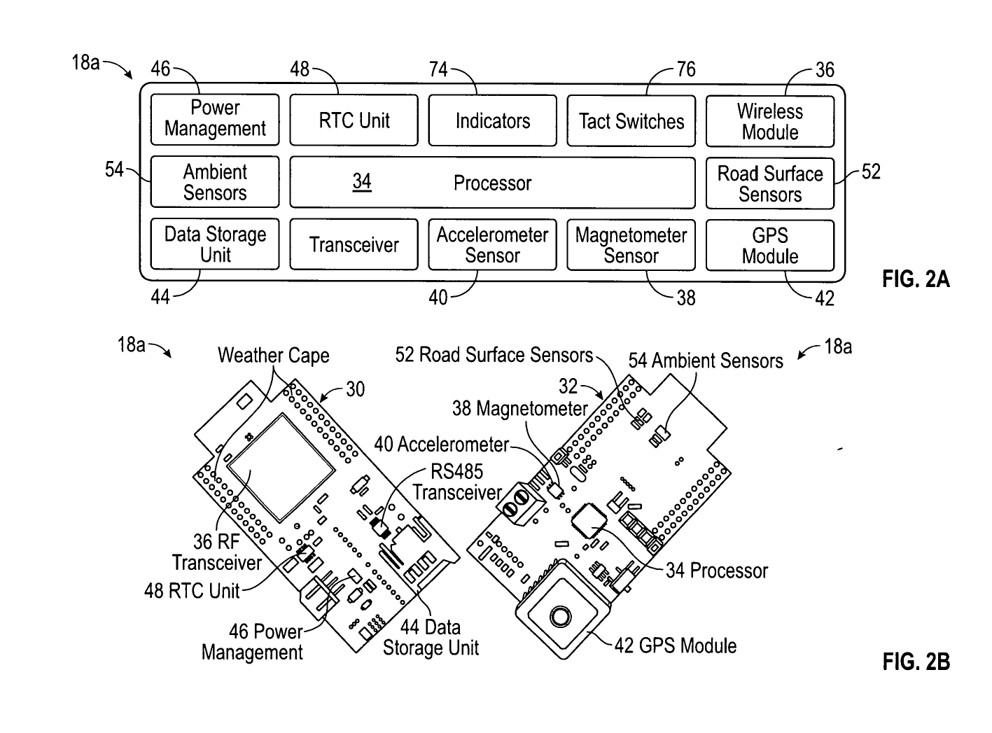

FIGS. 2A and 2B illustrate an exemplary embodiment of a node 18a for use within the system 10 illustrated in FIG. 1. The node 18a generally includes elements selected to achieve minimal power consumption while maintaining low cost and high-performance. The node 18a may be implemented on a printed circuit board (PCB) with components distributed on multiple layers 30 and 32 (e.g., top and bottom).

The node 18a includes one or more processors 34, one or more wireless modules 36, one or more magnetometers 38, one or more accelerometers 40, a GPS module 42, one or more data storage units 44, a power management unit 46, a real time clock (RTC) unit 48, a power charging receiver 50, one or more road surface sensors 52, and one or more ambient sensors 54.

The one or more processors 34 for each node 18a may be selected for high-performance and pico-power. The processor 34 may include a processor core, memory, and programmable input-output peripherals. In some embodiments, the processor 34 may be a microcontroller. An exemplary microcontroller may be ATxmega1128A4 from Atmel [36], with a principal place of business in San Jose, Calif. The ATxmega128A4 is a high-performance, pico-power with rich peripherals microcontroller. Another exemplary microcontroller may be an ultralow power, high-performance 32-bit embedded microcontroller such as STM32L0, manufacturer by STMicroelectronics, having a principal place of business in Geneva Switzerland. The SYM32L0 is temperature-stable and has low power consumption with seven power modes.

In some embodiments, the processor 34 may include a single microcontroller for each node 18a. In some embodiments, the processors 34 may include, but are not limited to, implementation as a variety of different types of systems, such as a networked system having multiple microcontrollers physically located at a distance apart.

The wireless module 36 may provide data transmission to the iAP 20. In some non-limiting embodiments, the wireless module 36 may be an RF module providing wireless data transmission. As described herein, in one non-limiting embodiments, a wireless network between the node 18a and the iAP 20 may be facilitated through an IEEE 802.15.4 protocol with ZigBee on top. Among many available commercial ZigBee modules, one non-limiting example is an SM200P81RF Engine, manufactured by Synapse, with a principal place of business in Huntsville, Ala. [35]. Such a system transmits power of 3 dBm with a range of 1500 feet and data transfer rate up to 2 Mbps with power consumption as low as 0.250 μA. The SM200P81RF also incorporates Synapse's mesh network operating system facilitating multi-hop, instant-on, self-healing, and internet-enabled mesh networking between network devices. Another non-limiting example is AW5161P0 based on NXP JN5168 manufactured by NXP Semiconductors, having a principal place of business in Austin, Tex.

The magnetometer 38 may be a 3-axis magnetometer used for measuring magnetic disturbance to the Earth's magnetic field caused by one or more vehicles. The accelerometer 40 may be a 3-axis accelerometer sensor used to measure road surface acceleration (e.g., vertical acceleration) resulting from motion of dynamic loads. Generally, both the magnetometer 38 and/or the accelerometer 40 may be selected for low power consumption and a wide measurement range, high resolution, low noise density, high sensitivity, low output noise range, ability to manage a high disturbing field, low cost, and/or lower power consumption. Additionally, in some embodiments, the magnetometer 38 and/or accelerometer 40 may use micro-electro-mechanical (MEMS) technology aiding in cost, size, weight and energy [38]. In some embodiments, the magnetometer 38 and the accelerometer 40 may be combined in a single device. An exemplary magnetometer 38 and accelerometer 40 for use in the node 18a may be a model FXOS8700CQ, manufactured by NXP Semiconductor, having a principal place of business in Austin, Tex. [37]. Another exemplary magnetometer 38 and accelerometer 40 for use in the node 18a may be a model KMX62, manufactured by Kionix, having a principal place of business in Ithaca, N.Y. KMX62 is a MEMs technology-based, high-performance, low-power inertial sensor coupled with an advanced ASIC.

The magnetometer 38 and the accelerometer 40 may be used for vehicle detection and/or vehicle classification [39]. The magnetometer 38 may detect a presence of a vehicle by measuring a disturbance to the Earth's magnetic field as the accelerometer 40 detects a number of axels of the vehicle by measuring vertical acceleration of a road surface due to motion of dynamic loads. Class may then be defined [31]. The accelerometer 40 may also be used to measure a road vertical acceleration for weight in-motion applications [40].

The GPS module 42 may be used to provide auto-localization and/or global synchronization. The GPS module 42 may be a compact multi-channel system and, in some embodiments, include a built-in patch antenna, for example. The GPS module 42 may be selected for low-power consumption and/or low cost. In some embodiments, the GPS module 42 may include a backup power module configured to run the RTC unit 48 during loss of power for the node 18a. As such, data regarding satellite information may be retained, locking satellites in less time on power up versus a cold start (e.g., 1 second versus 30 second on cold start). An exemplary GPS module 42 for use in the node 18a may include a Titan 2 Gms-g6 GPS module, manufactured by GlobalTop Technology with a principal place of business in Shanhua District, Tainan City, Taiwan [43]. Another exemplary GPS module 42 may be a model L76L-M33, manufactured by Quectel, having a principal place of business in Shanghai, China.

The one or more data storage units 44 may store raw data obtained from magnetometers 38, accelerometers 40, road surface sensors 52, and/or ambient sensors 54. For example, magnetometers 38 may sample the geomagnetic field at a high sampling rate and raw data may be stored within the one or more data storage units 44. In some embodiments, the data storage unit 44 may be a microSD card, such as the SanDisk microSD card, manufactured by SanDisk, with a principal place of business in Milpitas, Calif.

In some non-limiting embodiments, the data storage units 44 may include a microSD card and a serial NOR flash memory for data logging. For example, during traffic monitoring (e.g., vehicle counting, speed estimation, length-based classification), generally only detection timestamps may be needed in storage. The serial NOR flash memory may log the detection timestamps. An exemplary serial NOR flash memory may be from the model MX25R NOR Flash memory family, manufactured by Macronix, having a principal place of business in Taiwan.

Generally, the data storage unit 44 may remain in sleep mode except when accessed for data to read or write to conserve power. After completing an operation, the data storage unit 44 may retain (e.g., automatically) switch to and remain in sleep mode until a new command may be issued. Power consumption during page-write operation at 10 MHz rate may be, for example, 20 mA. Buffering data may be done prior to transferring to the data storage unit 44 as to have the data storage unit 44 remain in sleep mode for longer intervals.

To protect the data storage units from electrostatic discharge (ESD), electromagnetic interference (EMI), and/or transient voltage and current, one or more filters may be included. For example, a TI model TPD8F003, manufactured by Texas Instruments, having a principal place of business in Dallas, Tex., may be included within the node 18a.

The power management unit 46 may be configured for low-power design. Quiescent current (Iq) may be a comparison parameter for use to estimate battery run time. The power management unit 46 may include a voltage regulator, battery, and fuel gauge.

The voltage regulator may be an ultra-low quiescent current (e.g., Iq about 500 nA) with low dropout voltage (e.g., about 150 mV) linear voltage regulator. For example, the voltage regulator for the power management unit 46 for use in the node 18a may include TPS78333, manufactured by Texas Instruments, with a principal place of business in Dallas, Tex. The TPS78333 also includes thermal shutdown and overcurrent protection (e.g., 18 nA).

The battery may be a Li-Ion battery, for example. The fuel gauge may be used to protect the battery from deep-discharging. An exemplary fuel gauge may be a model MAX17043, manufactured by Maxim Integrated, with a principal place of business in San Jose, Calif. The fuel gauge may be configured to shutdown output in the event battery voltage drops below a predetermined threshold.

The real time clock (RTC) unit 48 may include a full-featured calendar, alarm, periodic wake-up, digital calibration, timestamp, and/or synchronization. The RTC unit 48 may be selected for accuracy and/or low cost. An exemplary RTC unit 48 for use in the node 18a may include a model DS3231M, manufactured by Maxim Integrated, having a principal place of business in Austin, Tex. [44]. In some non-limiting embodiments, the RTC unit 48 may incorporate a temperature-compensated MEMS resonator. In another non-limiting example, the RTC unit 48 for use in the node 18a may include the internal RTC unit in MCU model STM32L071 KB, manufactured by STMicroelectronics, having a principal place of business in Geneva, Switzerland.

Additionally, in some embodiments, the RTC unit 48 may further include a separate, accurate low speed external (LSE) oscillator for providing low power yet highly accurate clock source for RTC timing functions. The LSE may incorporate OSC32_IN and OSC32_OUT pins for crystal connection. As vehicles passing over and/or by the node 18a may negatively impact timing accuracy, temperature compensated crystal oscillators may be used. For example, a model SiT1552, manufactured by SiTime, having a principal place of business in Sunnyvale, Ca, may be routed directly to the OSC32_IN pin.

The node 18a may include one or more road surface sensors 52. The road surface sensors 52 may be configured to monitor road surface conditions and may include one or more temperature sensors and one or more wet-dry sensors. An exemplary temperature sensor for use as one or more road surface sensors 52 may include a negative temperature coefficient (NTC) resistor such as a model NXFT15WF104FA2B025, manufactured by Murata Electronics, with a principal place of business in Kyoto Prefecture, Japan. An exemplary wet-dry sensor for use as one or more road surface sensors 52 may be an impedance grid resistor (IGR). In some non-limiting embodiments, the road surface sensors 52 may be connected via a low-pass filter (LPF) to the processor 34.

In some non-limiting embodiments, road surface sensors 52 may include one or more NTC glass-based Thermistors. NTC glass-based Thermistors feature a fast response time, high reliability, and an operating temperature range between −50 degrees Celsius and +300 degrees Celsius. In some embodiments, the NTC glass-based Thermistors may be coated to ensure moisture-proof robustness.

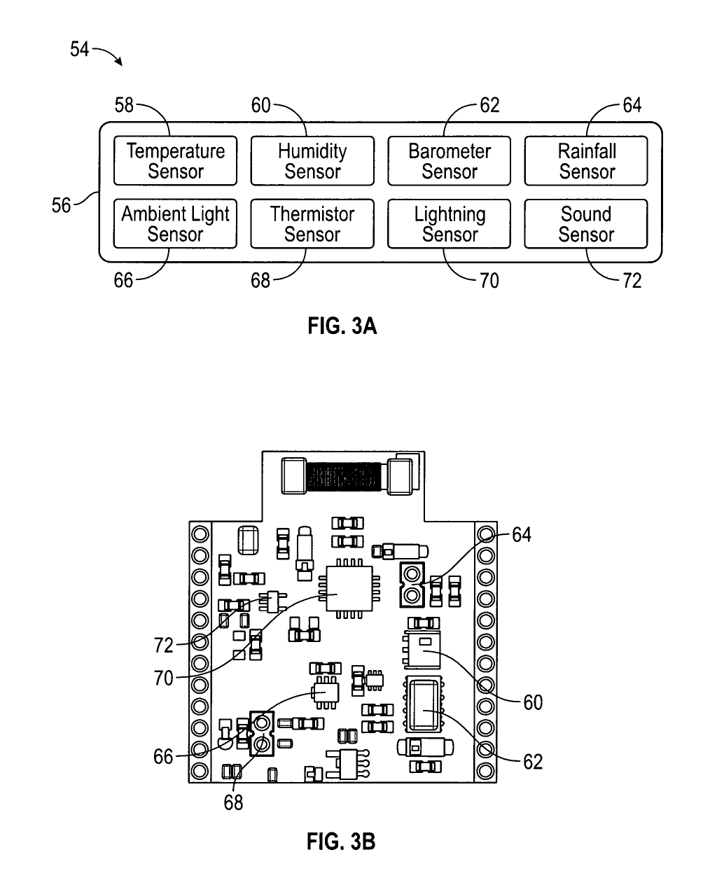

The node 18a may include one or more ambient sensors 54. The ambient sensors 54 may provide atmospheric measurements. Referring to FIGS. 2A, 3A, and 3B, in some embodiments the ambient sensors 56 may be included on a weather-sensing module (WSM). The weather-sensing module 56 may include one or more temperature sensors 58, humidity sensors 60, barometer sensors 62, rainfall sensors 64, ambient light sensors 66, thermistor sensors 68, lightning sensors 70, and/or sound sensors 72. Selection of each of the ambient sensors 56 may be configured for sensitivity, accuracy, power consumption, size, cost, and/or communication interface (i.e., analog or digital). An exemplary temperature sensor 58 for use in the weather-sensing module 56 is TMP102, manufactured by Texas Instruments, having a principal place of business in Dallas, Tex. An exemplary humidity sensor 60 for use in the weather-sensing module 56 is a model HTU21D, manufactured by TE Connectivity, having a principal place of business in Schaffhausen, Switzerland. An exemplary barometer sensor 62 for use in the weather-sensing module 56 is a model MPL3115A2, manufactured by NXP Semiconductors, having a principal place of business in Austin, Tex. An exemplary light sensor 66 for use in the weather-sensing module 56 is a model MAX44009, manufactured by Maxim Integrated, having a principal place of business in Austin, Tex. An exemplary lightning sensor 70 for use in the weather-sensing module 56 is a model AS3935, manufactured by AMS, having a principal place of business in Unterpremstatten, Austria. An exemplary sound sensor 72 for use in the weather-sensing module 56 is a model ADMP401, manufactured by Analog Devices, having a principal place of business in Norwood, Mass.

Additionally, the node 18a may include one or more indicators 74 configured to provide status and/or condition of the node 18a. Indicators 74 may be visual, audial, tactile, and/or the like. For example, one or more indicators 74 may be an LED indicator.

In some embodiments, the node 18a may include one or more tact switches 76. The tact switch 76 may be a tactile electromechanical switch configured to react to user interaction with a button and/or switch when contact is made.

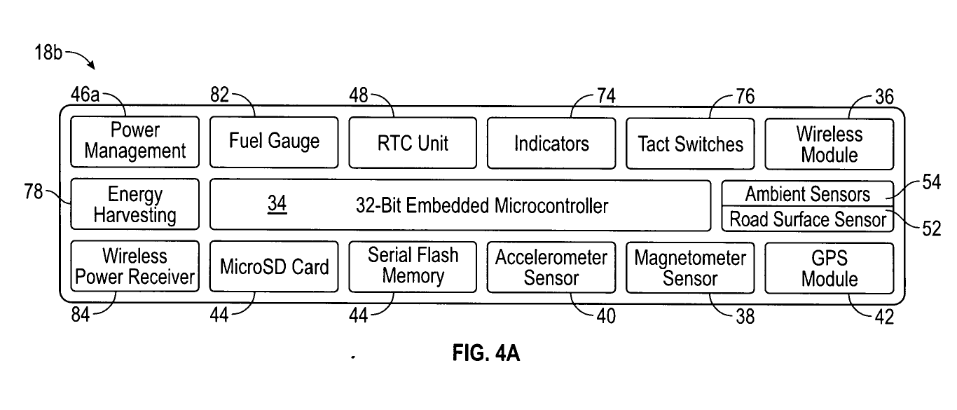

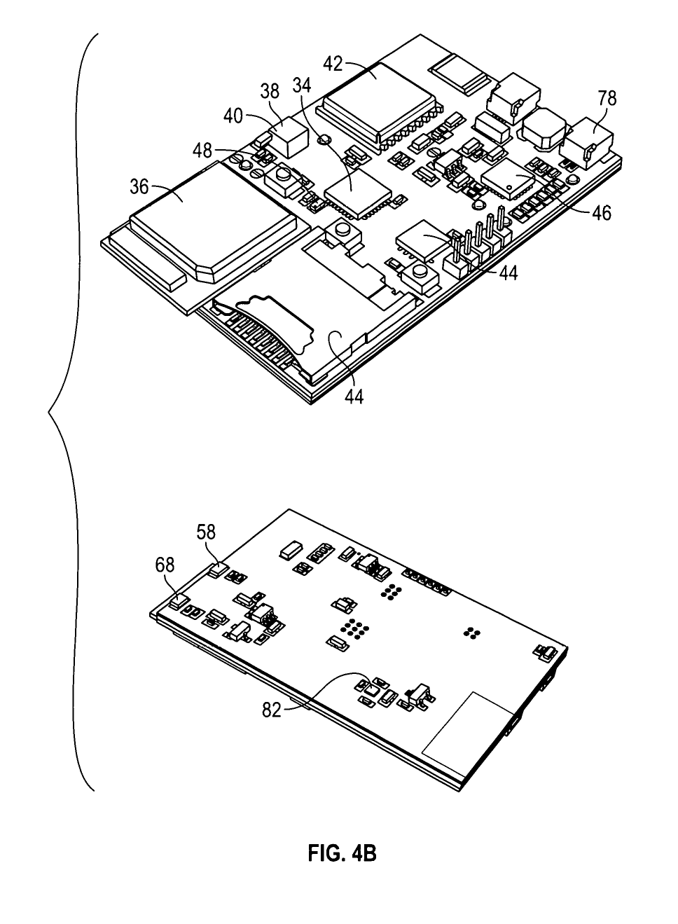

FIGS. 4A, 4B, and 5 illustrate another exemplary non-limiting embodiment of a node 18b for use in the traffic monitoring system 10 illustrated in FIG. 1. Generally, the elements of the node 18b and the node 18a are similar in construction with the node 18b including a power management unit 46a, an energy harvesting system 78, energy storage device 80, battery fuel gauge 82, and wireless power charging receiver 84. The processor 34 may have access to all systems to control energy distribution and ensure energy used is minimized when energy is not available at the input. Additionally, one or more load switches 86 may activate or deactivate a subsystem such as the wireless module 36, GPS module 42, data storage units 44, and/or sensors 38, 40, 52 and/or 54.

The energy harvesting system 78 may derive energy from external energy sources 88 (e.g., solar power, thermal energy, wind energy, salinity gradients, kinetic energy, and the like). Generally, the energy harvesting system 78 may have maximum power point tracking (MPPT) and charge management controllers for collecting energy. Exemplary energy harvesting systems 78 for use in the node 18b may include a model ADP5091, manufactured by Analog Device, having a principal place of business in Cambridge, Mass., wherein power may be harvested from sources with a 16 μW to 600 mW range. An internal 150 mA regulated output, for example may be programmed by an external resistor. MPPT may extract maximum possible energy from the energy source 88, which has varying impedance dependent on physical parameter changes. MPPT may keep the input voltage ripple in a fixed range to maintain stable DC-DC boost conversion in some embodiments. A minimum operation threshold may be programmed to enable boost shutdown during low input voltage conditions (e.g., night). Quiescent current during DC-DC boost may be 450 nA, and 360 nA when the boost is in shutdown mode.

The energy harvesting system 78 may also include a charging control function to protect rechargeable energy storage by monitoring voltage of the energy storage 80 via programmable charging termination voltage and/or shutdown discharging voltage. In some embodiments, the energy harvesting system 78 may be configured to turn off the DC-DC inverter, preventing interference during data transmission.

In some embodiments, the energy harvesting system 78 may include energy harvesting (EH) transducers configured to collect ambient energy before conversion to electrical power. EH transducers may include systems configured to collect energy sources 88 such as, photovoltaic, piezoelectric, electromagnetic, thermoelectric, and/or the like. For example, EH transducers may include solar cells, for example.

The energy storage device 80 may be any device configured to conserve harvester energy including, but not limited to, rechargeable batteries, supercapacitors, thin-film batteries, solid state energy chips, and/or the like. For example, the energy storage device 80 may be a rechargeable battery. To maximize battery cycle, a rechargeable battery may be selected having higher storage capacity to reduce depth of discharge (DoD), which is proportional to battery lifecycles. A battery having a higher capacity may have lower internal resistance, allowing more peak current to supply the load. Reducing DoD to a partial discharge and avoiding over-charge may significantly reduce stress and prolong life of the rechargeable battery. Most Li—Po batteries, for example, charge to 4.2V per cell; however, reducing peak charge voltage by 0.10V per cell may double battery cycle life. Consequently, a lower peak charge voltage may reduce the nominal capacity the battery may handle. For battery longevity, the battery may be set to a charge voltage of 3.92V per cell, to eliminate voltage-related stress.

The fuel gauge 82 may be any device configured to provide information regarding state of the energy storage device 80. By monitoring state of the energy storage device 80, deep-discharging and/or over-charging may be avoided. An exemplary fuel gauge 82 for use in the node 18b may include a model BQ27621-G1, manufactured by Texas Instruments, having a principal place of business in Dallas, Tex. The fuel gauge 82 may include a smart chip configured to use algorithms to calculate remaining battery capacity, state-of-charge, battery voltage, temperature, and/or the like. Data may be accessed by the processor 34.

The power management system 46a may be a voltage regulator for conditioning voltage of the node 18b and supplying components of the node 18b with appropriate operation voltage. An exemplary power management system 46a may be a model ADP165, manufactured by Analog Devices, having a principal place of business in Norwood, Mass.

The node 18b may also include the wireless power charger 84. The wireless power charger 84 may utilize electromagnetic energy transmitted from a primary coil of an energy transmitter in the near-field across a gap to a secondary coil of an energy receiver such that both coils are tuned to resonate at the same frequency. The receiver converts inductive current into energy that may be used to charge the energy source 80 and/or power the node 18b. An exemplary wireless power charger 84 may be a model BQ51051B, manufacturer by Texas Instruments, having a principal place of business in Dallas, Tex.

It should be noted that design of the node 18b may further consider leakage current, not only from active components, but also from passive components (e.g., capacitors). Additionally, effects of DC bias, temperature variation, and tolerance of bypass capacitors, as well as technology of selected capacitors may be evaluated for selection of active and passive components.

The nodes 18a and 18b may operate in online and offline modes. In offline mode, all traffic measurements, events, and magnetic signatures may be logged into data storage units 44. In online mode, data may be reported external to the node 18a or 18b using the wireless module 36 to either iAP 20 or other collaborative nodes 18. In some non-limiting embodiments, for conserving power, the data storage units 44 may remain in sleep mode except when accessed by either iAP 20 or other collaborative nodes 18.

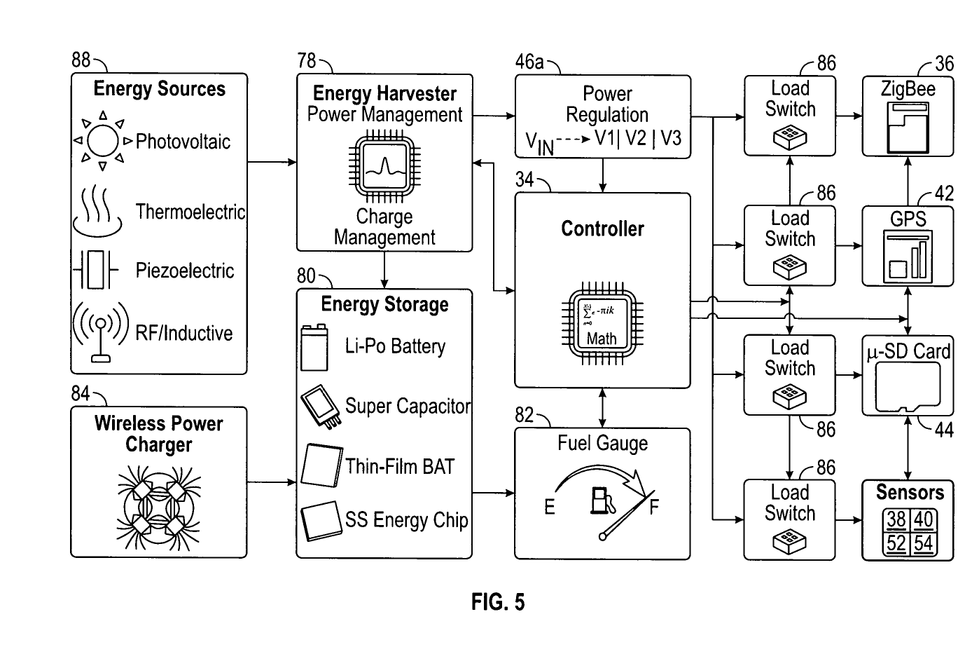

Referring again to FIGS. 1 and 6, data collected by elements of the node 18 may be analyzed and determined for vehicle detection, speed estimation, geomagnetic field baseline drift compensation, time-synchronization, RTC drift correction, and the like as discussed herein. For example, individual vehicles may be classified by their unique magnetic signature. Further, in some non-limiting embodiments, magnetic signature may be used to identify a particular vehicle. Using the vehicle magnetic signature, individual vehicles, groups of vehicles, classes of vehicles, and/or the like, may be tracked at different locations (e.g., origin, destination, route) using one or more nodes 18 and/or iAP 20. Additionally, processing of data collected by the one or more nodes 18 may at the Tier 2 and/or Tier 3 level as shown in FIG. 1. FIG. 6 illustrates the exemplary relationships between algorithm and associated interconnection with physical components of the node 18.

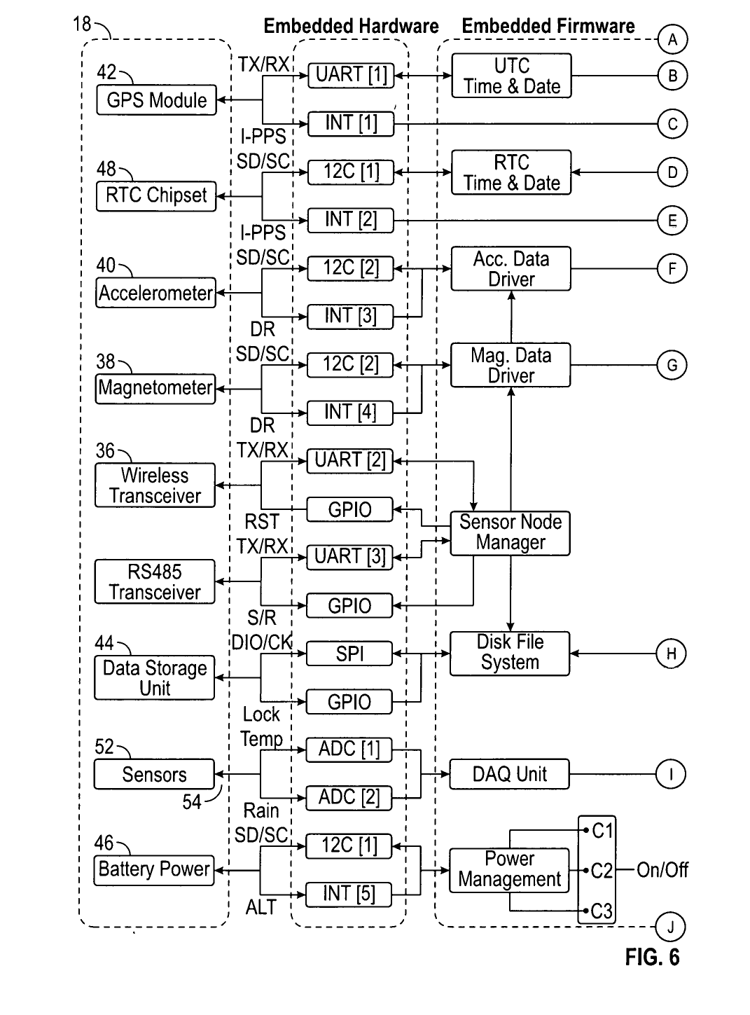

Referring to FIGS. 7-10, a five-state machine process algorithm, as described herein, may be used for real-time vehicle detection and counting using one node 18. The algorithm generally acts as an observer for disturbance in the Earth's magnetic field instigated by a passing vehicle. The Earth's magnetic field is nearly uniform, ranging between approximately 25 and 65 microtesla (μT) at the Earth's surface. However, direction and intensity of Earth's magnetic field changes from place-to-place over time. For example, in Oklahoma, USA, current field intensity is FM≈51 μT, which is magnitude of three geomagnetic field components: North BX≈21.95 μT, East BY≈1.135 μT, and vertical BZ≈46 μT components [46].

Vehicles have a significant amount of ferrous materials (e.g., iron, steel, nickel, or cobalt) that cause a small local disturbance in the Earth's magnetic field flux lines. Different vehicles have different structures, hence, different disturbance factors to geomagnetic field components. This disturbance represents a vehicle's magnetic signature, which is unique for different vehicles and can be measured using the magnetometer sensor 38 within the node 18. Localized flux lines may pull away from the node 18 as a vehicle 100 passes the node 18 and push back toward the node 18 as the vehicle drives away as shown in FIG. 7, creating fluctuations in F_{M}.

Each vehicle has a unique repeatable signature regardless of the speed of the vehicle. The higher the speed, the fewer number of samples per second. Accurate vehicle counting, however, does not demand a high sampling rate. Increasing sampling rates may increase signal fluctuation and hence misdetection. Accurate vehicle speed/length estimation may be provided using two nodes 18 at a known distance d.

For detection of the magnetic signature, various sampling rates ranging from 8 Hz to 200 Hz have been reported [17], [21], [47]-[49]. Using the traffic monitoring system 10, however, sampling rate may not be fixed. Instead, the magnetometer may be configured within the range of 0.781 Hz to 1600 Hz and the accelerometer may be configured in the range 0.781 to 25.6 Khz to best-fit the application. Increasing the sampling rate may increase resolution of sampled vehicle magnetic signatures. Notably, sensor noise output and power consumption may also increase. Output noise range of the magnetometer sensor 38 may be between 0.3-1.5 μT_{RMS} for a sampling rate of 0.781-1600 Hz, respectively. Magnetic noise density at 100 Hz bandwidth may be less than 0.1 μT/√Hz, for example.

In some non-limiting embodiments, an optimal sampling rate may be determined for a particular application. Assuming, for example, that a vehicle travels on a highway at a maximum speed limit (e.g., 140 kmh), and that the number of samples represent the vehicle's magnetic signature S_{SVL}, a given sampling rate f and vehicle length l may be calculated using EQ. 1.

$${S}_{VSL} = 3.6 \times ( \frac{{l}_{lde} + {l}_{tde} + l}{v} ) \times f \qquad EQ . 1$$

Vehicle magnetic length is defined as the disturbance caused by vehicle structure, and depends on a detection zone of the node 18. Leading and trailing detection edges of the detection zone are denoted as l_{ide} and l_{tde}, respectively. Assuming that l=5 meters, f=200 Hz, l_{ide}=l_{tde}=1.1 meter, then using EQ. 1, S_{VSL}=7 samples. For f=400 Hz, then S_{VSL}=74 samples. Eight samples would be sufficient for the vehicle detection application. However, for vehicle classification based on magnetic signature, a higher number of samples may be needed to extract unique features.

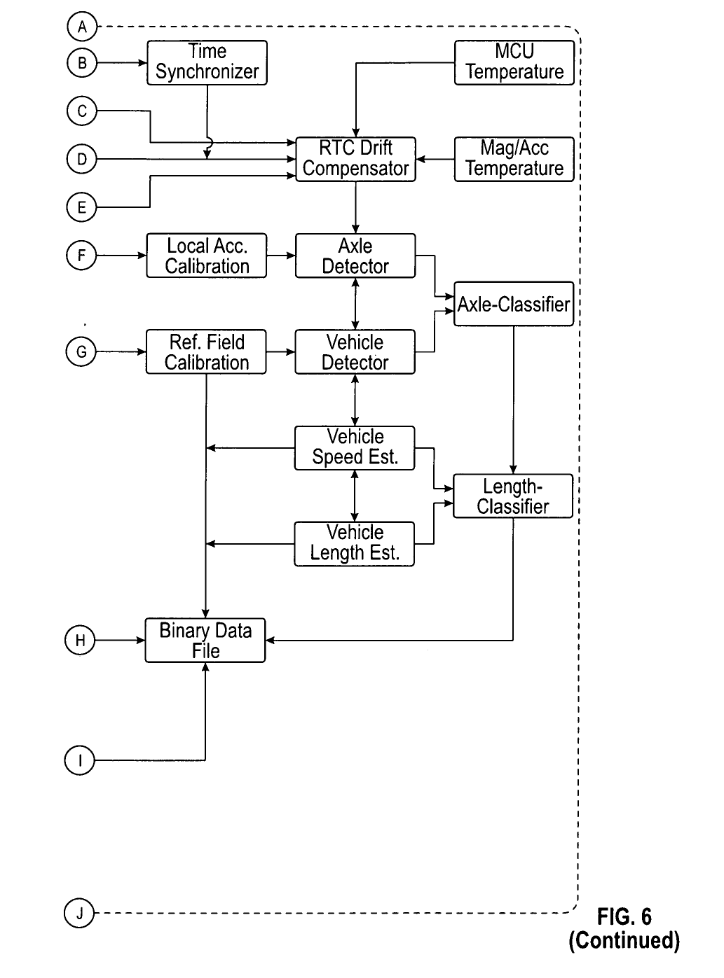

The five-state machine process algorithm determines fluctuations for vehicle detection by leveraging a plurality, e.g., three adaptive threshold (TH) and three adaptive debounce timers (DT) as shown in FIG. 8. The three thresholds are onset threshold O_{TH} (i.e., vehicle arrival), holdover threshold H_{TH} (i.e., vehicle departure), and baseline threshold R_{TH} (i.e., re-calibration call). The three adaptive debounce timers (DT) are onset debounce timers O_{DT} (i.e., eliminates misdetection and false events due to a glitch or transient state); holdover debounce timer H_{DT} (i.e., eliminates misdetection due to fluctuations when part of the vehicle has relatively small magnetic density (e.g., long truck); and detection period debounce timer P_{DT} (i.e., indicates stationary detection).

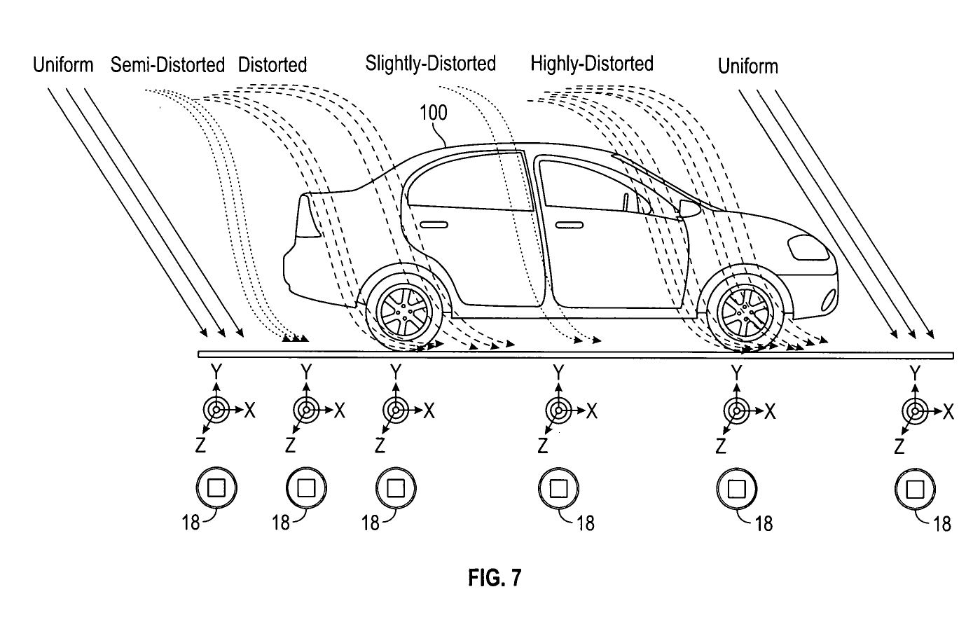

The five state machine process algorithm was developed based on MCU interrupts (INT) and an event system to ensure real-time performance and offloading to prolong battery life. FIG. 9 illustrates a finite state machine (FSM) diagram 102 for the five-state machine process detection algorithm.

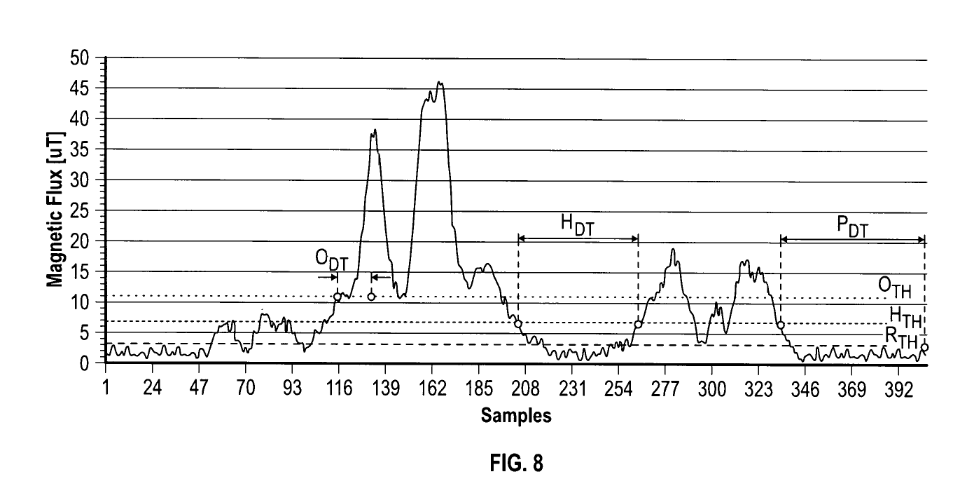

FIG. 10 illustrates a process diagram 104 for the five state machine process detection algorithm. Generally, upon power up of the node 18, an initialization process 106 may trigger a calibration state 108 wherein the magnetometer sensor 38 may sample localized reference magnetic field components (B_{XREF}, B_{YREF}, B_{ZREF}) for a period T_{S} in the absence of vehicles. During this time, the reference magnetic field flux magnitude F_{Mref} may be calculated using EQ 2:

F_{Mref}(k)=\sqrt{B_{Xref}(k)²+B_{Yref}(k)²+B_{Zref}(k)²} (EQ. 2)

The magnetic field flux magnitude is normally distributed with a mean μ and a standard deviation σ, R_{TH} may be estimated using EQ 3:

R_{TH}=μ+2σ (EQ. 3)

Consequently, O_{TH} and H_{TH} may be estimated using EQ. 4 and EQ. 5, wherein α and β may be constants defined according to the detection zone, and α>β to provide a hysteresis property in detection.

O_{TH}=μ+α×σ (EQ. 4)

H_{TH}=μ+β×σ (EQ. 5)

Once calibration is complete, the node 18 may remain in idle state 108 until INT1 triggers the O_{DT} state 112 given F_{M(k)}≧O_{TH} (i.e., a vehicle is in the detection zone). F_{M(K)} may be calculated using EQ. 6.

$${F}_{M} ( k ) = \sqrt{\begin{matrix}{( {B}_{X} ( k ) - {B}_{Xref} )}^{2} + \\ {( {B}_{Y} ( k ) - {B}_{Yref} )}^{2} + \\ {( {B}_{Z} ( k ) - {B}_{Zref} )}^{2}\end{matrix}} \qquad ( EQ . 6 )$$

O_{DT} state 112 may be a configurable timer used to filter false events. When INT1 triggers, B_{X(k)}, B_{Y(k)}, and B_{Z(k)} are logged. A transition into Detect state 114 occurs after O_{DT} state 112 is elapsed and the condition F_{M(k)}≧O_{TH} is true. In Detect state 114, the node 18 samples the field, calculates F_{M(k)}, and logs data into a storage memory. Field sampling is based on INT3, which occurs at specified sampling rate. A transition from Detect state 114 to H_{DT} state 116 occurs when condition F_{M(k)}<H_{TH} is true. This indicates that the vehicle departed the detection zone. In some embodiments, H_{DT} value must be optimized to minimize false departure error due to fluctuations in F_{M(k)}. A detailed modelling for H_{DT} is discussed below. A transition into Idle state 110 occurs when INT4 triggers after H_{DT} state 114 is elapsed and the condition F_{M(k)}<H_{TH} is true. Vehicle counter is then incremented, and both time of arrival and time of departure are logged. The node 18 may remain in Idle state 110 until INT1 is triggered again or F_{M(k)}≧R_{TH} (i.e., a drift in the localized magnetic field baseline).

Detection period debounce-timer P_{DT} 118 may be configured according to the intended application. For example, P_{DT} 118 may be used as a watch-dog-time on highways to clear errors resulting from an accidental change in field baseline during a detection event (e.g., high speed loaded truck hitting a node 18) and to trigger recalibration. P_{DT} 118 may also be configured as a stationary detection timer for parking lot applications.

The node 18 may be deployed on roadsides adjacent to a road lane, center of a road lane, and/or the like. The traffic monitoring system 10 uses the algorithm as indicated in FIG. 10 for vehicle detection. However, if a motorcycle or small vehicle is driving on a far side of the road lane opposite the node 18, the SNR may be significantly low, causing misdetection. To mitigate, a moving average filter (MAF) with gain coefficient w may be employed to reduce signal fluctuations and increase signal SNR using EQS. 7 and 8.

$$\begin{matrix} {F}_{Mgain} ( k ) = \frac{w}{N} {\sum }_{i = 0}^{N = 1} {F}_{M} ( k - i ) ; \\ w = 4 , \\ N = 5 & ( EQ . 7 ) \\ {F}_{Mgain} ( k ) = \begin{matrix}w \times \frac{{F}_{M} ( k ) + {F}_{M} ( k - 1 ) + … + {F}_{M} ( k ) ;}{k} ; k < N \\ w \times \frac{{F}_{M} ( k ) + {F}_{M} ( k - 1 ) + … + {F}_{M} ( k )}{k} ; k \geq N\end{matrix} & ( EQ . 8 )\end{matrix}$$

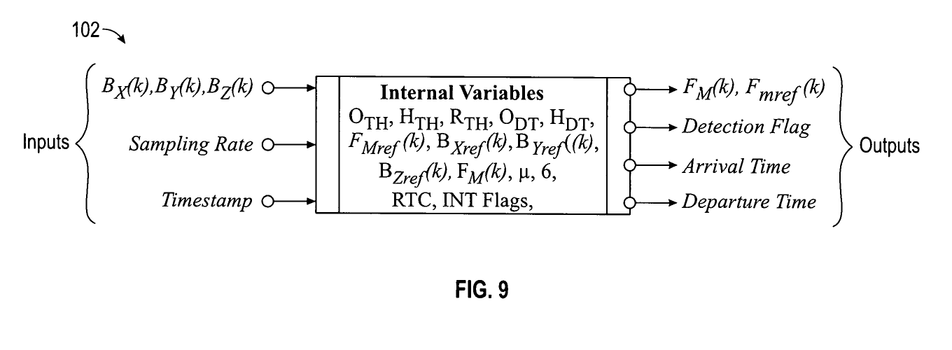

Variations in temperature, vibrations, aging, saturation, and background noise may cause a drift in the mean value of F_{Mref(k)}, which may cause a double-detection or misdetection with unreliable speed and length estimation. Thus, F_{Mref(k)} may be updated such that B_{Xref(k)}, B_{Yref(k)}, and B_{Zref(k)} may be compensated for any drift. Tracking F_{Mref(k)} may be achieved using MAF when F_{M(k)}<O_{TH}. The algorithm may determine new B_{Xref(k)}, B_{Yref(k)}, and B_{Zref(k)} values using the flow chart 120 illustrated in FIG. 11.

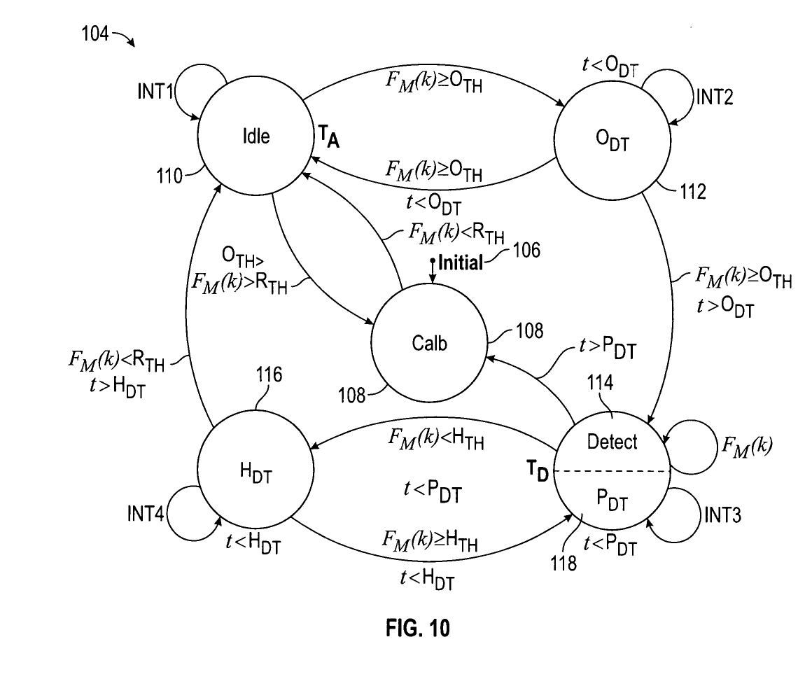

Referring to FIG. 12, real-time speed estimation of the vehicle 100 may be determined using a first node 18c and a second node 18d. Generally, the first node 18c and the second node 18d may be longitudinally positioned and separated by distance d as shown in FIG. 12.

Generally two measures of speed may be identified: 1) per-vehicle or instantaneous speed v̅ₗ, the attained speed of the vehicle 100 at time instant t, and 2) aggregated or time-mean speed v̅ₜ, the average speed of n vehicles v over time period t at a specific location. Instantaneous speed v̅ₗ and time-mean speed v̅ₜ may be calculated using EQ. 9 and EQ. 10 respectively wherein T_{A}^{N}^{ᵢ} is the arrival time of the vehicle 100, T_{D}^{N}^{ᵢ} is the departure time of the vehicle 100, and q is the number of vehicles traveling at the same speed.

$$\begin{matrix}\begin{matrix}{\overline{v}}_{l} \approx \frac{d ( {N}_{A} \to {N}_{B} )}{{T}_{A}^{{N}_{B}} - {T}_{A}^{{N}_{A}}} \\ \approx \frac{d ( {N}_{A} \to {N}_{B} )}{{T}_{D}^{{N}_{B}} - {T}_{D}^{{N}_{A}}} \\ \approx 2 \frac{d ( {N}_{A} \to {N}_{B} )}{{T}_{A}^{{N}_{B}} - {T}_{A}^{{N}_{A}} + {T}_{D}^{{N}_{B}} - {T}_{D}^{{N}_{A}}}\end{matrix} & ( EQ . 9 ) \\ \begin{matrix}{\overline{v}}_{t} = \frac{1}{n} {\sum }_{i = 1}^{n} {\overline{v}}_{i} \\ = \frac{{\sum }_{i = 1}^{n} {q}_{i} {\overline{v}}_{i}}{{\sum }_{i = 1}^{n} {q}_{i}} \\ = \frac{{\sum }_{i = 1}^{n} {q}_{i} d}{{\sum }_{i = 1}^{n} {q}_{i} {t}_{i}} \\ = \frac{{\sum }_{i = 1}^{n} {q}_{i} d ( {N}_{A} \to {N}_{B} )}{{\sum }_{i = 1}^{n} {q}_{i} ( {T}_{i}^{{N}_{B}} - {T}_{i}^{{N}_{A}} )}\end{matrix} & ( EQ . 10 )\end{matrix}$$

Timestamps may be sent by nodes 18 and received by iAPs 20. In some embodiments, the iAP 20 may determine speed and length estimation and/or classification.

In some embodiments, time synchronization may be performed to synchronize one or more nodes 18. Maximum timing error may be determined using EQ. 11. Optimal distance between nodes 18 may depend on speed range. Increasing such d may reduce timing error. Generally, distance between nodes 18 may be 3.1-3.7 meters for arterial setup and d=6.1-7.3 meters for freeway setup. The distance d, however, may be adjusted to accommodate maximum timing error.

$${T}_{SYNC - err} = \frac{d}{v} \times ɛ \qquad ( EQ . 11 )$$

Three interrelated parameters, vehicle magnetic length VML, speed v, and occupancy time T_{Occ}^{N}^{ᵢ} may be determined for each passing vehicle using the first sensor node 18c and the second sensor node 18d using EQ. 12.

V̅M̅L̅=v̅×T_{Occ}^{N}^{ᵢ} (EQ. 12)

Using EQ. 13, a single node 18 may be used to determined speed estimation using a moving median. The moving median uses a fixed window of n samples (i.e., vehicle speed values) centered on a current sample. The window moves one vehicle for each sample and calculates median speed for the current vehicle, and so on. A sample buffer may be selected with enough size to ensure minimal speed estimation error.

$${v}_{median} = \frac{{VML}_{average}}{median ( {T}_{D}^{{N}_{X}} - {T}_{A}^{{N}_{X}} )} \qquad ( EQ . 13 )$$

Given the ratio of short to long vehicle fluctuations, the sequence method may be applied to further improve speed estimation. As an occupancy time ratio between two successive vehicles may be proportional to their length, a ratio threshold may be determined between the mean of long vehicles (LV) and short vehicles (SV) based on solely on occupancy time as shown in EQ. 14 and EQ. 15, respectively. Given multiple sequences within the sample window, the algorithm estimates speed for each sequence and assigns median speed from all individual estimates to the sample. Otherwise, given no such sequences within the sample window, the algorithm falls back to the moving median method.

$$\begin{matrix}{\hat{v}}_{LV} = \frac{{L}_{LV}^{A}}{{( {T}_{D}^{{N}_{X}} - {T}_{A}^{{N}_{X}} )}_{LV}} & ( EQ . 14 ) \\ {\hat{v}}_{SV} = \frac{{L}_{SV}^{A}}{{( {T}_{D}^{{N}_{X}} - {T}_{A}^{{N}_{X}} )}_{SV}} & ( EQ . 15 )\end{matrix}$$

Referring to FIGS. 1 and 2, in some non-limiting embodiments, time synchronization may be accomplished through the GPS module 42. Each node 18 relies on the GPS module 42 and RTC unit 48 that are globally synchronized to the GPS pulse-pre-second (PPS) signal. As such, wireless connectivity may not be necessary for accurate functioning of nodes 18. Time stamping, timekeeping, and failure recovery functions may be enabled via the processor 34 and RTC unit 48, calibrated and aligned using the PPS signal.

Upon power-up of the node 18, the processor 34 may enable the GPS module 42 via an ultra-low, quiescent-current load switch. Once the GPS module 42 is successfully locked to available satellite(s), the Coordinated Universal Time (UTC) information packet may be used to set time and date with the RTC unit 48. The rising edge of PPS signal, which is globally synchronized with 10 ns timing accuracy, may be used to align clock phase of the RTC unit 48. As such, WSN-node RTC clocks may be independently synchronized to the same reference signal (i.e., PPS) on a global scale without exchanging messages over the wireless network. Once the RTC unit 48 is synchronized, the processor 34 may set the GPS module 42 in backup mode. Location coordination of the node 18 and its identifier may be reported to the corresponding iAP 20 for mapping purposes.

Accuracy of the RTC unit 48 may be dependent on a crystal oscillator (e.g., 32 Khz_{OSC}) with maximum resolution of 30.517 μs. The accuracy may be subject to several factors, including manufacturing tolerances in the 32 Khz_{OSC}, passive PCB components, temperature excursions, aging and/or the like. The primary time-synchronization error when using the RTC unit 48 may be caused by the 32 Khz_{OSC} frequency drift.

The node 18 may use a low profile crystal oscillator having an extended temperature operation between approximately −55 degrees Celsius and +125 degrees Celsius. Output of the 32 Khz_{OSC} may have parabolic frequency dependence over temperature. Frequency drift at temperature T may be expressed in EQ. 16 wherein β is a temperature coefficient, given in ppm/T², that is always negative (i.e., RTC oscillator slows down at cold or hot temperatures around T_{O}). T₀ may be a turnover temperature.

$$\frac{Δ f}{{f}_{0}} = β {( T - {T}_{0} )}^{2} \qquad ( EQ . 16 )$$

The 32 Khz_{OSC} drift ε_{RTC} at constant T has a slope m=1, meaning that change in ε_{RTC} is constant over time at contact temperature. Measuring ∈_{RTC} at 26 degrees Celsius for one hour may show a constant drift of 15 μs, for example, which may be modelled as a linear equation as shown in EQ. 17, wherein \hat{t}_{RTC} is corrected for RTC time; t_{GPS} is GPS time at calibration moment; and ε_{RTC}^{T}^{_{OSC}} is the accumulated error at T_{OSC}.

\hat{t}_{RTC}=m×t_{RTC}±ε_{RTC}^{T}^{_{OSC}} (EQ. 17)

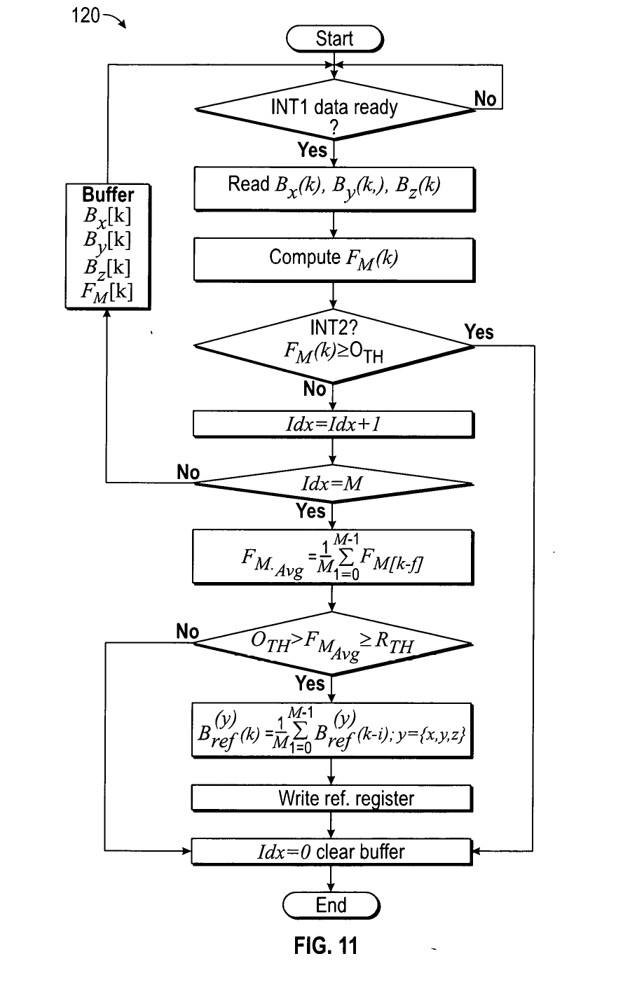

Referring to FIG. 13, any temperature variation may cause drift in output of the RTC unit 48. To maintain time-synchronization error within an intended range, RTC drift may be tracked for compensation to correct t_{RTC} drift by knowing T_{OSC}. Corresponding frequency drift may then be calculated, with respect to time, using EQ. 16 and correct RTC time may be determined using EQ. 17. The objective is to reject disturbances (i.e., variations in T_{OSC}). In some embodiments, measuring T_{OSC} is not possible as the oscillator does not have a built-in temperature sensor. The temperature, however, may be determined using surrounding components of the RTC unit 48. The node 18 may use the thermistor sensor 68 and/or temperature sensor 58 to extrapolate an estimated temperature of the oscillator. As such, realignment of the RTC unit 48 may be determined at a pre-determined temperature variation of oscillator (e.g., 3 degrees Celsius). Additionally, a re-synchronization using GPS may also be repeated at pre-determined intervals (e.g., every two hours) to correct for residual errors.

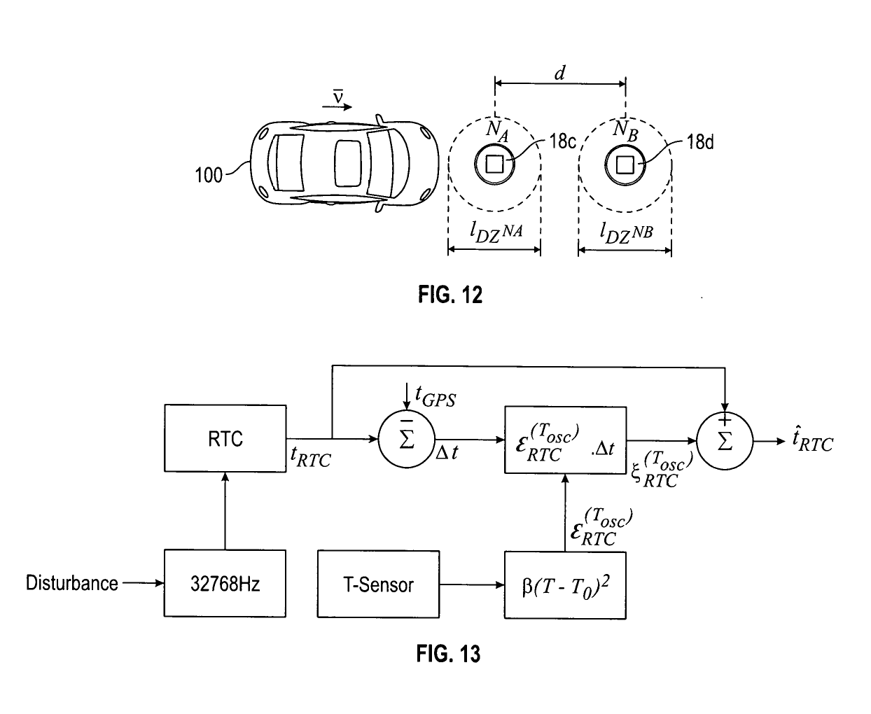

FIG. 14 illustrates a block diagram of another exemplary method for correcting drift of the RTC unit 48. Generally, signal frequency of the RTC unit 48 may be compared to an accurate reference frequency (e.g., PPS signal frequency). Both clocks may be sampled using a high frequency clock f_{TCLK}^{MCU} driven from the oscillator of the processor 34. As both signals are measured using the same clock at the same time, tolerance error is cancelled out. If T_{OSC} changes (e.g., approximately 3 degrees Celsius), the algorithm awakens the GPS module 42, aligns the RTC phase, and computes a new time correction coefficient.

Once RTC phase is aligned, the algorithm may configure two 16-bit counters (Cnt1 and Cnt2) in an overflow interrupt (OVI) mode. Cnt1 may be triggered by an external interrupt, generated on the rising edge of a GPS-PPS signal. Cnt2 may be triggered by 1-sec RTC timer interrupt, which is generated each time the RTC times reaches the top value and then transitions to zero. Elapsed time at Cnt1 or Cnt2 overflow interrupt may be calculated using EQ. 18.

$${Cnt}_{Tmax}^{( i )} = \frac{{2}^{N} \times {D}_{v}}{{f}_{TCLK}^{( MCU )}} \qquad ( EQ . 18 )$$

As 2.048 ms may be a maximum count time for Cnt1 and Cnt2, 488.28125 OVIs may be required to count 1-sec, as evident in EQ. 19. OVI fraction value may be equal to 0.28125/65536=18432 count. Total number of counts, calculated by EQ. 20 may be a number of OVI multiplied by counter precision plus the residual value in the counter register. A new time correction coefficient may be calculated as in EQ. 21, wherein Cnt_{avg}⁽ⁱ⁾ is the average count of n measurements (i.e., n-sec).

$$\begin{matrix}{OVI}_{1 s}^{( {Cnt}^{( i )} )} = \frac{{t}_{target}}{{Cnt}_{Tmax}^{( i )}} & ( EQ . 19 ) \\ {Cnt}_{Total}^{( i )} = [ {2}^{N} \times {OVI}^{( {Cnt}^{( i )} )} ] + {Cnt}^{( i )} & ( EQ . 20 ) \\ {ɛ}_{RTC}^{( {T}_{OSC} )} = \frac{{Cnt}_{avg}^{( 2 )} - {Cnt}_{avg}^{( 1 )}}{{f}_{TCLK}^{( MCU )}} & ( EQ . 21 )\end{matrix}$$

The value ε_{RTC}^{(T}^{_{OSC}}⁾ provides timing error (i.e., drift), or in other words, a difference between measured periods of a GPS-PPS-1 Hz reference signal and a RTC-1 Hz signal.

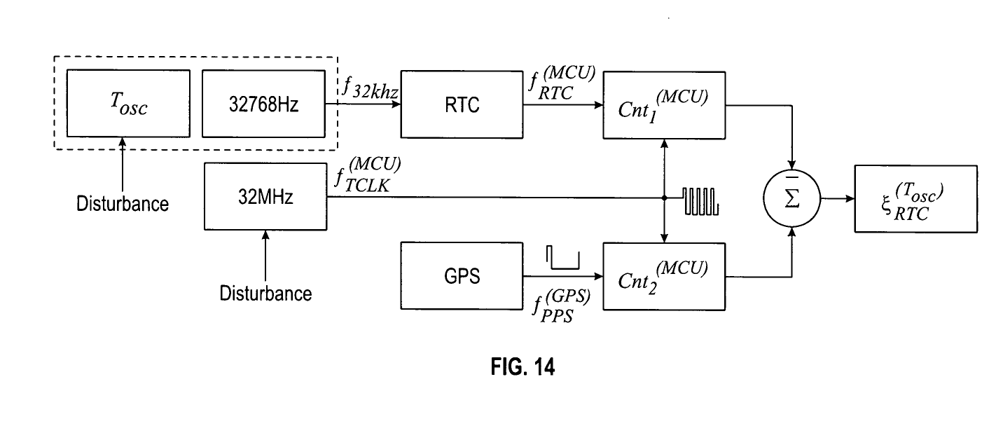

Once the correction process is complete, the GPS module 42 may be set to a power-down mode. The correction algorithm may be executed at regular intervals (e.g., pre-determined intervals) to adjust and/or realign the RTC phase and keep nodes 18 synchronized. FIG. 15 illustrates a flow chart representation of RTC frequency drift compensation using GPS-PPS signal.

In some non-limiting embodiments, the node 18 may include a crystal oscillator 130 such as the SiT1152, described previously herein. The crystal oscillator may include a MEMS resonator and programmable analog circuit. The temperature coefficient may be factory calibrated and corrected over multiple temperature points using an active temperature correction circuit to ensure extremely tight frequency variation over a temperature range (e.g., −40 degrees Celsius to +85 degrees Celsius). The processor 34 (e.g., STM32L0) may implement an RTC calibration register (i.e., CALP-CALM) that may be used to increase or decrease the clock of the RTC unit 48 using EQ. 22. After the RTC phase is aligned using the GPS module 42, all nodes 18 may be kept synchronized by calculating the clock error of the RTC unit 48 when temperature is changed, and then adjusting RTC calibration registers.

$${f}_{CAL}^{( RTC )} = {f}_{CLK \_ IN}^{( RTC )} 1 + \frac{( CALP \times 512 ) - CALM}{{2}^{20} + ( CALM ) - ( CALP ) \times 512} \qquad ( EQ . 22 )$$

Vehicle arrival and departure timestamps may be sent by each node 18 to the associated iAP 20 for vehicle speed and length estimation, as well as, classification. In some cases, due to interference from other technologies (e.g., operating in the Ism band, heavy truck passing detection zone), the channel may be degraded, resulting in delayed events. As a unique identification is assigned to each node 18, the identification may be combined with the arrival and departure timestamp and sent to the iAP 20 simultaneously. In the case of a missing arrival timestamp or departure timestamp, the corresponding arrival timestamp or departure timestamp will be deleted.

Vehicle magnetic length may be used for classification of vehicle. The vehicle magnetic length (VML) is defined as a disturbance in the Earth's magnetic field caused by a vehicle structure. VML may be estimated from the product of vehicle speed and sensor occupancy time T_{Occ}^{N}^{ᵢ} as shown in EQ. 23. The sensor occupancy time is defined as the difference between vehicle departure and arrival times at a designated detection point. Both may be influenced by magnetic field detection threshold.

$$\begin{matrix}\overline{VML} = \overline{v} \times {T}_{OCC}^{{T}_{i}} \\ = \overline{v} \times ( {T}_{D}^{{N}_{i}} - {T}_{A}^{{N}_{i}} ) \\ = \overline{v} \times \frac{{T}_{D}^{{N}_{A}} - {T}_{A}^{{N}_{A}} + {T}_{D}^{{N}_{B}} - {T}_{A}^{{N}_{B}}}{2}\end{matrix} \qquad ( EQ . 23 )$$

As disturbance level to the Earth's magnetic field depends on vehicle composition of ferrous materials, VML may be longer than physical length of the vehicle (i.e., bumper to bumper length). However, under the assumption that symmetrical detection zone and sensor sensitivity are independent of vehicle structure, physical length of the vehicle may be estimated using EQ. 24.

lᵥ=l_{M}−l_{DZ}^{(N}^{ᵢ}); [symbol] ≈v̅ₗ[T_{D}^{(N}^{_{B}})−T_{A}^{(N}^{_{A}})]−d^{N}^{_{A→NB}} (EQ.24)

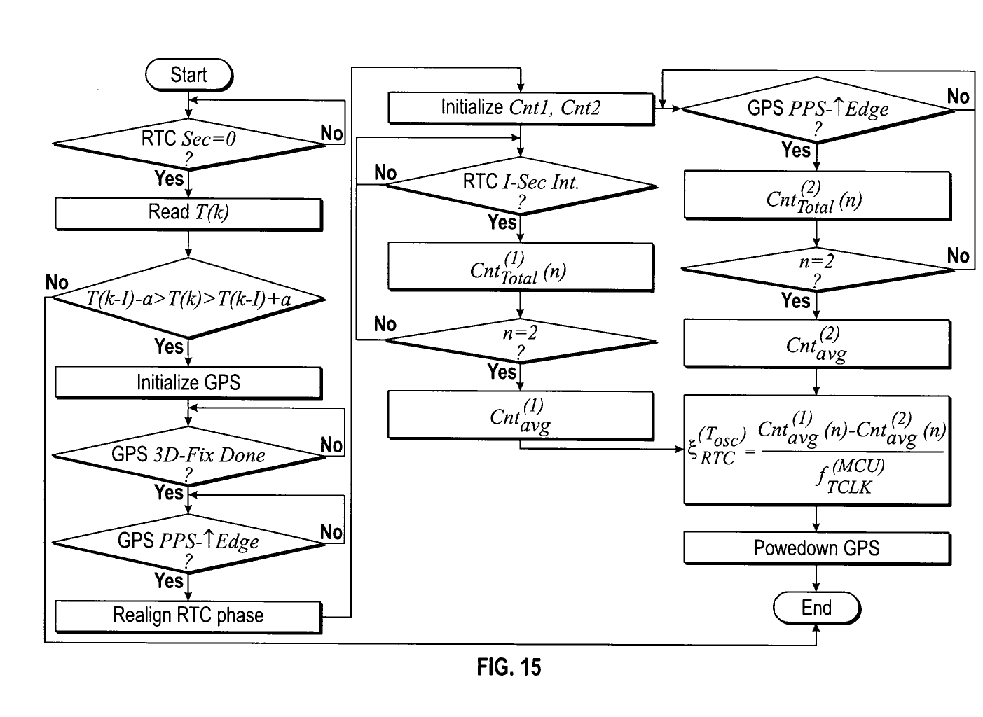

Referring to FIGS. 16-18, vehicles' magnetic signatures have different variations and patterns. Three distinctive length-based vehicle classification (LBVC) schemes are shown in FIG. 16. Vehicles may be grouped in each bin based on structural similarity and statistical data. The MC group may include motorcycles. The PV group may include passenger cars, pickups, and SUVs. Short-trailer group (ST) may include busses, light-trucks, and single-unit-trucks. Long vehicles (L/LT) may include single-trailer and multi-trailer trucks.

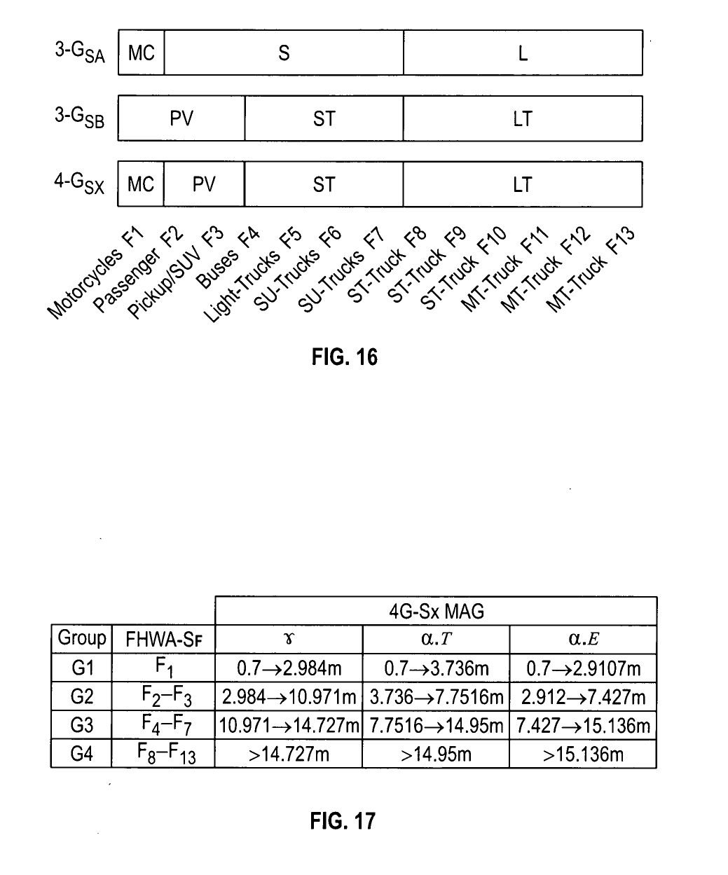

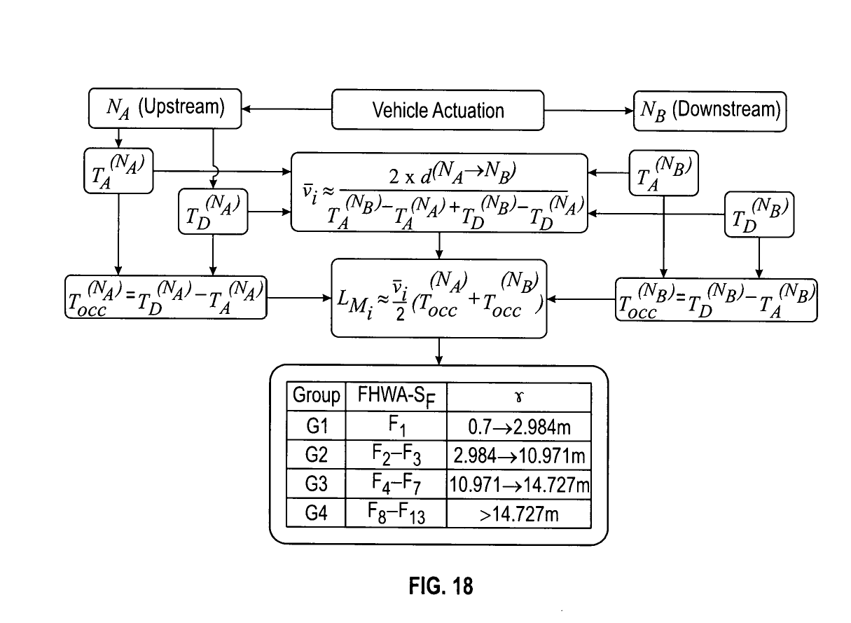

Vehicles of different classes may be sorted, according to their magnetic length into multiple groups (G), each group combines n-class (Fₙ) such that G1:{F1}, G2:{F2,F3}, G3 {F4-F7}, G4 {F8-F13} as shown in FIG. 17. The length decision boundaries for 4-G_{SX} may be determined using different thresholding methods (i.e., γ, ατ, αε). Categorization of the vehicle's class may improve the accuracy and performance of the classification algorithm. Once the category is known, some common features and frequencies may be extracted from the vehicle magnetic signature to differentiate between different classes within the same group. The boundaries may be implemented in real-time using if-then conditions. An implementation model for LBVC scheme using magnetometer is depicted in FIG. 18.

In some embodiments, one or more intelligent classification algorithms may learn to classify vehicles into predefined classes by statistically modelling the relationship between vehicle class and probabilistic distribution of features set (or predictors) extracted from vehicle magnetic signature. Classification algorithms may include, but are not limited to Decision Trees, Support Vector Machine, k-Nearest Neighbour, Naive Bayes Classifier, and/or the like.

Separating two neighbouring classes from each other may be treated as a binary problem. As such, probabilistic models may be employed to determine optimal boundary decisions to separate neighbouring classes whose vehicles may include overlapping lengths. Probabilistic models may be implemented in real-time, require no training sets, and improve classification accuracy by minimizing classification errors.

Signature-based vehicle classification (SBVC) systems may be used to classify vehicles using MAG. The SBVC system may statistically model the relationship between a vehicle's class and the probabilistic distribution of features extracted from the vehicle's magnetic signature. In some non-limiting embodiments, sixty different features extracted from the vehicle's magnetic signature may be used. Such features may be related to the length of the vehicle magnetic signature, energy of the vehicle magnetic signature, moments of the vehicle magnetic signature, shape symmetry ratio of the vehicle magnetic signature, shape symmetry degree of the vehicle magnetic signature, number of peaks and/or valleys, change ratio in signal energy polarity, hill patterns, and/or the like. Principal Components Analysis (PCA) may be used to reduce dimensionality of the features and selection of distinctive features that may be used to efficiently distinguish between classes. One or more classification algorithms may then be used to model the relationship between a vehicle's class and the probabilistic distributions of the feature set.

Vehicles may be modelled magnetically as an infinitely large number of magnetic dipoles, each with its own moment and direction in a three-dimensional space. magnetometer measures geometric sum of all dipoles on x, y and z-axes. As a result, a vehicle may be considered a single dipole with a moment equal to geometric sum of all dipoles. Hence, F_{M} may be the same regardless of sensor orientation. However, B_{X}, B_{Y} and B_{Z} may be different for rotation angle Θ. If Θ is known, component values may be calculated before and after rotating sensor Θ radians around z-axis using EQ. 25.

$$[ \begin{matrix}{B}_{x}^{′} \\ {B}_{y}^{′} \\ {B}_{z}^{′}\end{matrix} ] = [ \begin{matrix}cos Θ & sin Θ & 0 \\ sin Θ & cos Θ & 0 \\ 0 & 0 & 1\end{matrix} ] [ \begin{matrix}{B}_{X} \\ {B}_{Y} \\ {B}_{Z}\end{matrix} ] \qquad ( EQ . 25 )$$

Three detection errors may be observed if magnetometer is used for vehicle detection: mis-detection (i.e., two successive vehicles at close proximity grouped as one), double-detection (i.e., long vehicle with insignificant ferrous composition in the center), and false-detection (i.e., interference from adjacent lanes (e.g., large trucks)). Both mis-detection error and double-detection errors may be eliminated using a holdover debounce timer (H_{DT}). To minimize mis-detection and double-detection errors, H_{DT} value should satisfy the condition of g_{T}>H_{DT}>S²_{T}, where g_{T} is the gap time between departure of vehicle i and arrival of vehicle i+1 at a designated detection point and S²T is the time of central section of a long vehicle. H_{DT} optimal value can be found statistically from traffic characteristic.

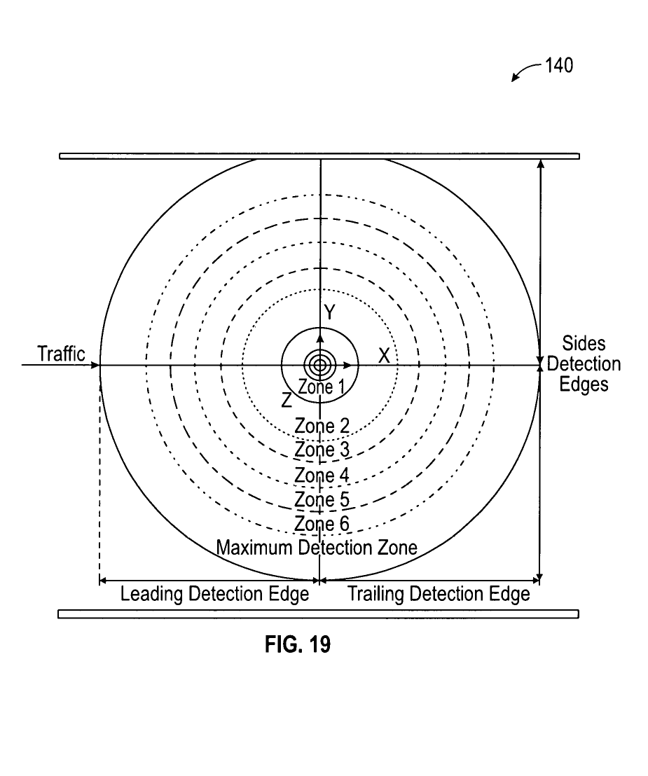

Referring to FIG. 19, false-detection error may be initially eliminated by defining a sensor detection zone (DZ) 140. In general, DZ 140 may be defined at five detection edges of the vehicle: 1) leading, 2) trailing, 3) right-side, 4) left side, and 5) elevation edge. Notably, the leading edge generally includes the highest magnetic disturbance as vehicles contain the majority of ferromagnetic mass in the front section (e.g., engine). Detection zones may be controlled by either changing magnetometer sensor sensitivity or changing detection thresholds, O_{TH} and H_{TH}, wherein α and β may be calibrated to control detection zone 140 and eliminate interference outside of the detection region. While increasing O_{TH} and H_{TH} may prevent false-detection, the magnetic signature may be altered rendering an unreliable estimation of vehicle length and loss of features for vehicle classification. To solve this issue, variations in B_{X}, B_{Y}, and B_{Z} may be analyzed to measure vehicle effect on an adjacent lane interfering on each component and a decision may be made whether Vₙ is a real detection or an interfering signal. In particular, by computing μB_{Z} using EQ. 26, and then comparing μB_{Z} for each detected vehicle (Vₙ) with threshold I_{TH}, a decision may be made whether is a real detection or an interfering signal.

$$μ {B}_{Z} ( {V}_{n} ) = \frac{1}{N} {\sum }_{k = 1}^{N} ( \frac{1}{M} {\sum }_{i = 0}^{M - 1} {B}_{Zm} ( k - i ) ) \geq {I}_{TH} ; \\ {B}_{Zm} ( k ) = \sqrt{{( {B}_{Z} ( k ) - {B}_{Zref} )}^{2}} \qquad ( EQ . 26 )$$

Vehicle re-identification provides realization on the link travel time distribution. Vehicle re-identification using magnetometer may be dependent on matching an individual vehicle magnetic signature at two detection points (i.e., two nodes 18).

Generally, vehicle re-identification includes three steps. The first step is vehicle magnetic signature processing including time coding, signal smoothing, magnitude computation, signal windowing, and amplitude normalization. The second step includes unique features extraction. The third step is a matching process, wherein unique features being extracted from a vehicle magnetic signature at a downstream node 18 may be compared to a buffer of unique features for vehicles detected at an upstream node 18. Both upstream and downstream nodes 18 may be globally synchronized to the same reference clock (e.g., GPS-PPS signal).

In one example, the magnetic signature for each vehicle may be extracted by means of arrival and departure times at each detection point. As vehicle trajectory may not be identical at each detection point, additive combination, subtraction combination and ratio of the magnetic signature may be determined. Additionally, amplitude normalization may be performed to individually rescale each signal by the range of its elements prior to further calculations.

Feature extraction may be performed on each node 18 to find three sets of features for each normalized signal (i.e., X, Y, Z, and magnetite): 1) Perceptually Important Points (PIP); 2) Time Spacing between consecutive PIP; and 3) Piecewise Linear Function. The objective of data transformation is reducing dimensionality of the data while maintaining the unique characteristics of signal, hence, reducing the amount of data to be processed or transferred from the node 18 to the iAP 20.

In one example, PIP (i.e., the extrema of signal—local maxima and local minima points of a signal) may be found by calculating derivatives. In another example, PIP may be found by comparing each point in the signal with neighbouring points.

Time spacing between consecutive extrema points may be taken into consideration to improve vehicle re-identification accuracy in the event that signal amplitude may be different at two nodes 18 (e.g., vehicle trajectory changed). Time spacing may be calculated relative to arrival and departure time stamps or by determining the difference between time indices.

Piecewise Linear Function (PL) between consecutive extrema points may be determined by analyzing the linear relationship between amplitude and time spacing between extrema points.

Using the dynamic time warping (DTW) non-linear alignment algorithm, similarity between two temporal time series may be determined to find optimal mapping between two signals so that differences may be minimized. The signature matching process may be performed within a predetermined time window that matches vehicle signature detection at a downstream point with a number of signatures detected by the upstream point. The number of vehicles in a matching window may depend on traffic flow, distance, and/or segment flow speed limit between upstream and downstream points. The longer the distance, the larger the number of vehicles in the window buffer, and the less the re-identification rate. In some non-limiting embodiments, travel time may be estimated based on 0.5 mile spacing between nodes 18 on urban roads and 5 to 10 mile spacing between nodes 18 on highways.

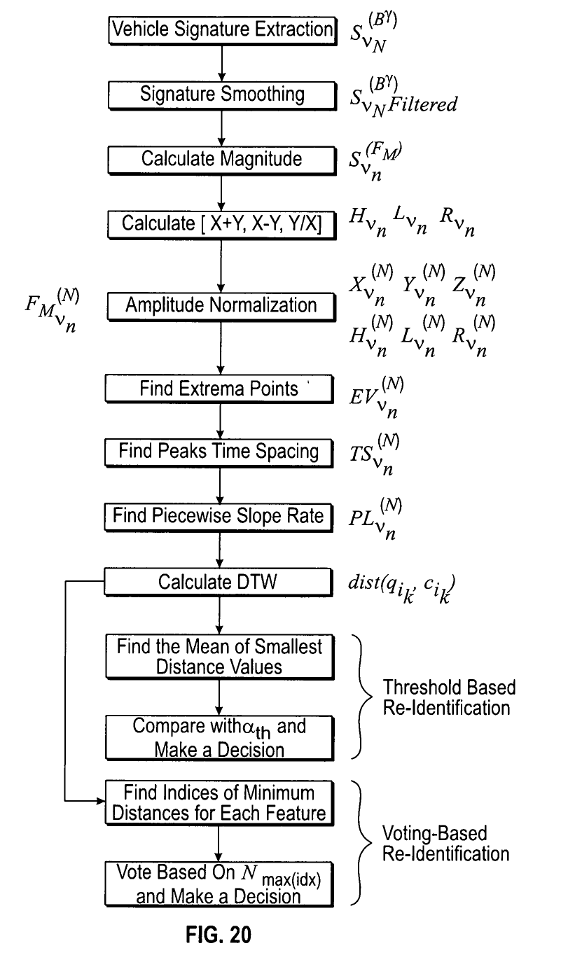

The decision on whether a value is classified as “identical” or “different” may be made using Threshold-based re-identification and/or majority voting-based re-identification. FIG. 20 illustrates a re-identification process for both methods.

The objective of Threshold-based re-identification is to provide an efficient matching function for classifying a calculated distance between upstream and downstream points into “Identical” or “Different” points. Generally, a statistical model of distance matrix between upstream and downstream detection points may be used to find a decision threshold for α_{Th} as shown in EQ. 27.

$$δ ( i ) = \{ \begin{matrix}1 & dist ( {q}_{i} , {c}_{j} ) \leq {α}_{Th} \\ 0 & dist ( {q}_{i} , {c}_{j} ) > {α}_{Th}\end{matrix} \qquad ( EQ . 27 )$$

To determine α_{Th}, an M×N×O distance matrix may be constructed of all pairwise signatures distances (qᵢ,cⱼ) calculated between upstream and downstream detection points with M being the number of vehicles upstream, N being the number of vehicles downstream, and O being the number of features.

Voting based vehicle matching uses a decision to which vehicle magnetic signatures in a window buffer may be matched to a current vehicle magnetic signature based on maximum number of minimum distances of vehicle magnetic signature features. The algorithm compares the distances for M upstream vehicle magnetic signature (qᵢ) in a window downstream vehicle magnetic signature (cⱼ) just detected; stores the indices of minimum distance values for each features in an M×2 matrix; and then votes for a matching decision based on maximum number of indices.

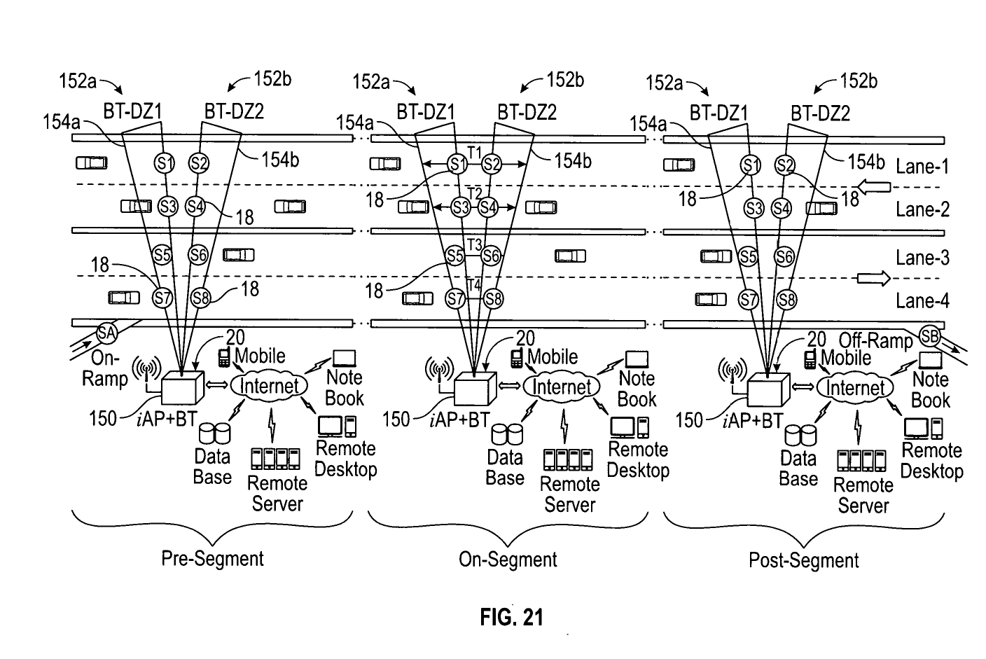

In some non-limiting embodiments, a media access control address (MAC) identifier may be correlated with a vehicle magnetic signature as illustrated in FIG. 21. For example, a unique Bluetooth (BT) MAC identifier may be correlated with a vehicle magnetic signature for a vehicle. Using the BT MAC identifier and other sensor detection provided by the node(s) 18 at a first location, route choice of one or more vehicles may be determined. In some non-limiting embodiments, a BT detector 150 may be housed with the iAP 20 and positioned at the first location. Alternatively, the BT detector 150 may be housed separately from the iAP 20. The BT detector 150 may include two or more directional antennas 152 providing detection zones 154. For example, in FIG. 21, two directional antennas 152a and 152b are used, BT-DZ1 and BT-DZ2. The directional antennas 152 form two detection zones 154a and 154b. One or more vehicles entering the detection zone 154a may be detected by the BT detector 150 (e.g., BT-DZ1), as well as, the node(s) 18. The BT detector 150 may receive BT signals and record BT signal detection time, zone, and/or one or more identifiers. The node 18 may provide vehicular information extracted from the vehicle magnetic signature as detailed herein. The unique magnetic signature determined via sensory information provided by the node 18 may be correlated with the unique MAC identifier provided by the BT detector 150. As the vehicle departs the detection zone 154a and enters the detection zone 154b, the BT detector 150 may receive BT signals and record BT signal detection time, zone and/or one or more identifiers. The unique MAC identifier of the first vehicle, correlated with the magnetic signature of the first vehicle, may be tracked using the BT detector 150 within the detection zones 154a and 154b. The process may be repeated at multiple detection zones 154 (i.e., detection zones 154 at a secondary location). To that end, using the BT signals provided by BT detectors 150 at multiple locations and sensory information provided by the node 18 at the first location as detailed herein, vehicle travel direction and time may be determined along a route via detection zones 154 at multiple location (i.e., secondary locations). It should be noted that at the detection zones 154 other than the first detection zone 154a, the use of one or more nodes 18 may be optional.

As shown herein, a novel node 18 has been designed and implemented. The node 18 provides a portable, self-powered (e.g., primary battery and/or solar cell), inexpensive, easy-to-install on highway surfaces, roadways, or roadsides without intrusive roadwork, and may accurately detect, count, estimate speed and length, classify and re-identify vehicles in real-time. The node 18 may be used for short-term deployment (e.g., work zone safety, temporary roadway design studies, traffic management in atypical situations such as evaluation) and long-term deployment (e.g., traffic management, turn movement, and collision avoidance).

Additionally, reliable and distinctive computationally efficient algorithms for real-time traffic monitoring were implemented. Optimization programming tasks were applied to improve detection algorithm performance at high sampling rates and compensate for drift in geomagnetic reference fields. An algorithm for adaptive compensation of RTC Frequency Drift resulting from variations in temperature was implemented. Additionally, each node 18 may rely on the GPS module 42 and RTC unit 48 to maintain an independent local clock that is globally synchronized to the GPS pulse-per-second (PPS) signal. Wireless connectivity may not be necessary for functioning of the node 18. Time stamping, timekeeping, and failure recovery may be enabled by the RTC unit 48, which is calibrated and aligned using the PPS signal. A time synchronization algorithm based on GPS-PPS signal was developed.

Further, by using statistical analysis to find an optimal holdover debounce timer HDT, mis-detection errors and double-detection errors were reduced. False-detection errors may be reduced by comparing a mean of vertical components to a threshold.

Several length based vehicle classification (LBVC) schemes and signature-based vehicle classification (SBVC) schemes were developed via machine learning algorithms and probabilistic modelling of VML. The LBVC models and SBVC models may provide real-time data and classification of vehicles.

Vehicle re-identification models based on matching vehicle magnetic signature from a single magnetometer were developed. Features extraction was performed on each node 18 to determine three sets of features for each signal including Perceptually Important Points, Time Spacing between consecutive points, and Piecewise Linear Function. The data transformation reduces dimensionality of the data while maintaining unique characteristics of signals, thus, reducing the amount of data to be processed or transferred from the node 18 to the iAP 20. The matching process implemented the DTW algorithm to calculate distance (i.e., similarity) between corresponding features at upstream and downstream detection points. The decision whether a calculated distance value may be classified as “Identical” or “Different” may be made using Threshold-based re-identification and/or Majority Voting-based re-identification. A statistical model of distance matrix between upstream and downstream detection points may be determined for a decision threshold that maximizes probability of matching and minimizing probability of incorrect matching. A majority voting-based algorithm makes a decision based on a maximum number of minimum distances for features.

The present disclosure includes an automated computerized system comprising a computer system executing traffic monitoring software. The traffic monitoring software reads data corresponding to a magnetic field of a first vehicle collected by a first node. The traffic monitoring software determines a unique magnetic signature for the first vehicle from the data collected by the first node, and correlates the first vehicle using the magnetic signature to a predefined vehicle class. The predefined vehicle class may group vehicles by structural similarity, for example. The first node may be positioned adjacent to a road land, in the center of the road lane, or anywhere within the road lane.

The traffic monitoring system may also read data corresponding to arrival time and departure time of the first vehicle collected by the first node and data corresponding to arrival time of the first vehicle collected by a second node. The second node may be longitudinally positioned from the first node and separated by a predetermined distance. The traffic monitoring software may determine speed of the first vehicle based upon the unique magnetic signature of the first vehicle, at least one of the arrival time and the departure time collected by the first node, and the arrival time of the first vehicle collected by the second node.

In some non-limiting embodiments, the traffic monitoring software may determine vehicle magnetic length of the first vehicle using an instantaneous speed and occupancy time data of the first vehicle. The traffic monitoring software may also correlate the first vehicle into predefined vehicle class using the vehicle magnetic length.

In some non-limiting embodiments, the traffic monitoring software may read data corresponding to arrival time and departure time of a plurality of vehicles collected by the first node and data corresponding to arrival time and departure time of the plurality of vehicles collected by the second node and determine average speed of the plurality of vehicles over a predefined time period.

In some non-limiting embodiments, the traffic monitoring system may read data corresponding to magnetic field of the first vehicle collected by a second node. The traffic monitoring system may determine a unique magnetic signature for the first vehicle from the data collected by the second node and use a vehicle re-identification process to match the magnetic signature from data collected by the first node to the magnetic signature from data collected by the second node.

The present disclosure also includes one or more non-transitory computer readable medium storing a set of computer executable instructions for running on one or more computer systems that when executed cause the one or more computer systems to receive data from a first node. The first node may have a plurality of sensors configured to detect signals and transmit the data to the computer system. The set of computer executable instructions may also cause the one or more computer systems to determine a unique magnetic signature of a first vehicle using data received from the first node and correlate the magnetic signature of the first vehicle to a predefined vehicle class. The predefined vehicle glass may group two or more vehicle structures.

The present disclosure also includes an automated method of classifying a vehicle comprising receiving data related to a first vehicle form a first node positioned on a roadway. The first node collecting a plurality of signals from at least one sensor and transmitting the signal to a processor. The method may also include the step of determining a unique magnetic signature of the first vehicle using the data collected from the at least one sensor and correlating the first vehicle to a vehicle class using the unique magnetic signature of the first vehicle. The vehicle class may be grouped by structural similarity. In some non-limiting embodiments, at least a portion of the processor may be within an intelligent access point. In some non-limiting embodiments, at least a portion of the processor is in an internet cloud computing center.

A sensory node for use in an autonomous, real-time traffic monitoring system, comprising at least one processor having pico-power performance; a real time clock unit; and at least one road surface sensor, at least one ambient sensor, at least one magnetometer, at least one accelerometer, and a GPS module configured to provide signals representative of data to the processor. The signals may be associated with one or more vehicles on a roadway. The GPS module may be configured to enable self-calibration of the real time clock unit and auto-localization of the node. The sensory node may also include at least one data storage unit for storing signals representative of data from the one or more vehicles and a wireless transceiver enabling real-time data transfer between the node and one or more intelligent access points.

In some non-limiting embodiments, the sensory node may include a power system enabling self-powering of the sensory node for predetermined times, the power system supplying energy to one or more elements of the node. The power system may include an energy storage device and an energy harvesting system configured to extract energy from at least one external source and provide the energy to the energy storage device. The power system may also include a wireless power receiver configured to facilitate remote charging of the energy storage device. In some non-limiting embodiments, the power system may include a fuel gauge configured to discontinue output of the energy storage device if voltage drops below a predetermined level and a power management unit configured to regulate energy from the energy storage device. In some non-limiting embodiments, a Bluetooth detector positioned at a distance from the processor may include at least two directional antennas configured to form a detection zone for extraction of Bluetooth signals associated with at least one vehicle.

In some embodiments, an automated computerized system may comprise a computer system executing traffic monitoring software. The traffic monitoring software may read data corresponding to magnetic field of a first vehicle collected by a plurality of nodes at a first region of a roadway. Additionally, the traffic monitoring software may read data corresponding to Bluetooth signal detection time, detection zone, and media access control (MAC) identifier of the first vehicle collected a Bluetooth detector at the first region of the roadway. The traffic monitoring software executed by the computer system may determine a unique magnetic signature for the first vehicle from the data collected by the plurality of nodes, and correlate the unique magnetic signature to the MAC identifier collected by the Bluetooth detector. Additionally, the traffic monitoring software may read data corresponding to Bluetooth signal detection time, detection zone, and media access control (MAC) identifier of the first vehicle at a plurality of secondary regions of the roadway by a plurality of Bluetooth detectors. The traffic monitoring software may determine travel direction and time of the first vehicle on the roadway using detection the detection times and detection zones collected by the Bluetooth detectors.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

### REFERENCES

[1] “FHWA Forecasts of Vehicle Miles Traveled (VMT): May 2014,” Office of Highway Policy Information, 2014. [Online]. Available: http://www.fhwa.dot.gov/policyinformation/tables/vmt/vmt_forecast_sum.cfm. [Accessed: 17 Apr. 2015].
2] N. N. C. for S. and Analysis, “Traffic Safety Facts—Research Note 2013 Motor Vehicle Crashes,” Washington, D C, 2014.
[3] National Highway Traffic Safety Adminstriation, “Traffic Safety Facts 2012 Data,” Washington, D C, 2014.
[4] National Highway Traffic Safety Adminstriation, “The Economic and Societal Impact Of Motor Vehicle Crashes,” Washington, D C, 2014.
[5] D. Schrank, B. Eisele, and T. Lomax, “TTI's 2012 URBAN MOBILITY REPORT Powered by INRIX Traffic Data,” 2012.
[6] C. C. D. US EPA, “Carbon Dioxide Emissions.” [Online]. Available: http://www.epa.gov/climatechange/ghgemissions/gases/co2.html.
[7] L. E. Y. Mimbela and L. a Klein, “A Summary of Vehicle Detection and Surveillance Technologies used in Intelligent Transportation Systems.”
[8] G. Orosz, R. E. Wilson, and G. Stépán, “Traffic jams: dynamics and control,” Philos. Trans. A. Math. Phys. Eng. Sci., vol. 368, no. 1928, pp. 4455-79, October 2010.
[9] S. Cheung, “Traffic Surveillance by Wireless Sensor Networks: Final Report,” 2007.
[10] F. H. Administration, “Traffic Monitoring Guide,” 2013.
[11] I. Khan, F. Belqasmi, R. Glitho, N. Crespi, M. Morrow, and P. Polakos, “Wireless Sensor Network Virtualization: A Survey,” IEEE Commun. Surv. Tutorials, pp. 1-1, 2015.
[12] F. Losilla, A.-J. Garcia-Sanchez, F. Garcia-Sanchez, J. Garcia-Haro, and Z. J. Haas, “A Comprehensive approach to WSN-based ITS applications: a survey,” Sensors (Basel)., vol. 11, no. 11, pp. 10220-65, January 2011.
[13] D. Tacconi, D. Miorandi, I. Carreras, F. Chiti, and R. Fantacci, “Using wireless sensor networks to support intelligent transportation systems,” Ad Hoc Networks, vol. 8, no. 5, pp. 462-473, July 2010.
[14] G. Padmavathi, “A Study on Vehicle Detection and Tracking Using Wireless Sensor Networks,” Wirel. Sens. Netw., vol. 02, no. 02, pp. 173-185, 2010.
[15] J. Jung and S. Park, “The Possibility of Wireless Sensor Networks for Commercial Vehicle Load Monitoring,” vol. 8, no. December, pp. 30-34, 2011.
[16] M. Bottero, B. Dalla Chiara, and F. P. Deflorio, “Wireless sensor networks for traffic monitoring in a logistic centre,” Transp. Res. Part C Emerg. Technol., vol. 26, pp. 99-124, January 2013.
[17] B. Yang and Y. Lei, “Vehicle Detection and Classification for Low-Speed Congested Traffic With Anisotropic Magnetoresistive Sensor,” IEEE Sens. J., vol. 15, no. 2, 2015.
[18] N. Wahlstrom, R. Hostettler, F. Gustafsson, W. Birk, N. Wahlstrom, S. Member, R. Hostettler, F. Gustafsson, W. Birk, N. Wahlstrom, R. Hostettler, F. Gustafsson, and W. Birk, “Classification of driving direction in traffic surveillance using magnetometers,” IEEE Trans. Intell. Transp. Syst., vol. 15, no. 4, pp. 1405-1418, 2014.
[19] R. D. Komguem, R. Stanica, M. Tchuente, F. Valois, R. Domga Komguem, R. Stanica, M. Tchuente, and F. Valois, “WARIM: Wireless Sensor Networks Architecture for a Reliable Intersection Monitoring,” in 17th International IEEE Conference on Intelligent Transportation Systems (ITSC), 2014, pp. 1226-1231.
[20] S. Taghvaeeyan and R. Rajamani, “Portable roadside sensors for vehicle counting, classification, and speed measurement,” IEEE Trans. Intell. Transp. Syst., vol. 15, no. 1, pp. 73-83, 2014.
[21] B. Koszteczky and G. Simon, “Magnetic-based vehicle detection with sensor networks,” in 2013 IEEE International Instrumentation and Measurement Technology Conference (I2MTC), 2013, pp. 265-270.
[22] K. Liu, H. Xiong, and H. He, “New method for detecting traffic information based on anisotropic magnetoresistive technology,” in Proc. SPIE 8783, Fifth International Conference on Machine Vision (ICMV 2012): Computer Vision, Image Analysis and Processing, 2013, p. 87830S.
[23] A. Kaadan and H. H. Refai, “iICAS: Intelligent intersection collision avoidance system,” in 2012 15th International IEEE Conference on Intelligent Transportation Systems, 2012, pp. 1184-1190.
[24] A. Daubaras and M. Zilys, “Vehicle Detection based on Magneto-Resistive Magnetic Field Sensor,” Electron. Electr. Eng., vol. 118, no. 2, pp. 27-32, February 2012.
[25] J. Lan, Y. Xiang, L. Wang, and Y. Shi, “Vehicle detection and classification by measuring and processing magnetic signal,” Measurement, vol. 44, no. 1, pp. 174-180, January 2011.
[26] L. Yalong, L. Bin, and W. Zhiqiang, “A novel method of automatic vehicle detection based on active magnetic theory,” in 2010 International Conference on Information, Networking and Automation (ICINA), 2010, vol. 2, pp. V2-382-V2-385.
[27] W. Zhang, G. Z. Tan, H. M. Shi, and M. W. Lin, “A distributed threshold algorithm for vehicle classification based on binary proximity sensors and intelligent neuron classifier,” J. Inf. Sci. Eng., vol. 26, no. 3, pp. 769-783, 2010.
[28] J. L. J. Lan and Y. S. Y. Shi, “Vehicle detection and recognition based on a MEMS magnetic sensor,” 2009 4th IEEE Int. Conf. Nano/Micro Eng. Mol. Syst., pp. 404-408, 2009.
[29] S. V. Marshall, “Vehicle detection using a magnetic field sensor,” IEEE Trans. Veh. Technol., vol. 27, no. 2, pp. 65-68, 1978.
[30] A. Haoui, R. Kavaler, and P. Varaiya, “Wireless magnetic sensors for traffic surveillance,” Transp. Res. Part C Emerg. Technol., vol. 16, no. 3, pp. 294-306, June 2008.
[31] R. I. S. J. H. Wyman, G. A. Braley, “Field evaluation of FWHA vehicle classification categories, executive summary, materials and research,” Washington, D.C., USA, 1985.
[32] “Sensor|Sensys Networks.” [Online]. Available: http://www.sensysnetworks.com/products/sensor/. [Accessed: 20 Apr. 2015].
[33] “Vehicle Detector WD-300|Sensebit.” [Online]. Available: http://www.sensebit.se/products/traffic-measurement/vehicle-detector-wd-300/. [Accessed: 20 Apr. 2015].
[34] “M100 Wireless Vehicle Detection System.” [Online]. Available: http://www.clearviewtraffic.com/golden-river/products-golden-river/art/44/m100-wireless-vehicle-detection-system.htm. [Accessed: 20 Apr. 2015].
[36] “ATMEL XMEGA MCU—ATxmega128A4U.” [Online]. Available: http://www.atmel.com/devices/atxmega128a4u.aspx. [Accessed: 21 Apr. 2015].
[37] “Freescale Digital Sensor—FXOS8700CQ.” [Online]. Available: http://www.freescale.com/webapp/sps/site/prod_summary.jsp?code=FXOS8700 CQ. [Accessed: 21 Apr. 2015].
[38] “MEMS-Based Sensor Technology|Freescale.” [Online]. Available: http://www.freescale.com/webapp/sps/site/overview.jsp?code=SNSMEMSOVERVIEW. [Accessed: 22 Apr. 2015].
[39] W. Ma, D. Xing, A. McKee, R. Bajwa, C. Flores, S. Member, B. Fuller, P. Varaiya, S. Member, B. Fuller, P. Varaiya, C. Author, D. Xing, A. McKee, R. Bajwa, C. Flores, and B. Fuller, “A wireless accelerometer-based automatic vehicle classification prototype system,” IEEE Trans. Intell. Transp. Syst., vol. 15, no. 1, pp. 1-8, 2014.
[40] R. S. Bajwa, “Wireless Weigh-In-Motion: using road vibrations to estimate truck weights,” 2013.
[41] “Synapse SM200P81 RF Engine.” [Online]. Available: https://www.synapse-wireless.com/documents/products/Synapse-SM200P81-Engine-Product-Brief.pdf. [Accessed: 22 Apr. 2015].
[42] “Synapse's SNAP Network Operating System,” David Ewing. [Online]. Available: http://synapse-wireless.com/documents/white_paper/Synapse-SNAP-OS-White-Paper.pdf. [Accessed: 22 Apr. 2015].
[43] “GlobalTop Technology Inc.—Titan 2 (GMS-G6).” [Online]. Available: http://www.gtop-tech.com/en/product/Titan-2-GMS-G6/GPS_Modules_Gms-g6.html. [Accessed: 22 Apr. 2015].
[44] “Maxim Integrated—DS3231M Real-Time Clock.” [Online]. Available: http://www.maximintegrated.com/en/products/digital/real-time-clocks/DS3231M.html. [Accessed: 22 Apr. 2015].
[45] “Maxim Integrated—MAX17043 Compact, Low-Cost 1S/2S Fuel Gauges with Low-Battery Alert.” [Online]. Available: http://www.maximintegrated.com/en/products/power/battery-management/MAX17043.html. [Accessed: 22 Apr. 2015].
[46] N. G. D. Center, “NGDC Geomagnetic Calculators.”
[47] D. Obertov, V. Bardov, and B. Andrievsky, “Vehicle speed estimation using roadside sensors,” in 2014 6th International Congress on Ultra Modern Telecommunications and Control Systems and Workshops (ICUMT), 2014, pp. 111-117.
[48] M. Isaksson, “Vehicle Detection using Anisotropic Magnetoresistors,” CHALMERS UNIVERSITY OF TECHNOLOGY, Sweden, 2008.
[49] F. Palhinha, D. Carona, A. Serrador, and T. Canas, “Wireless Magnetic Based Sensor System for Vehicles Classification,” Procedia Technol., vol. 17, pp. 632-639, 2014.

What is claimed is:

1. An automated computerized system, comprising:
a computer system executing traffic monitoring software reading:
data corresponding to magnetic field of a first vehicle collected by a first node;
wherein the traffic monitoring software executed by the computer system determines a unique magnetic signature for the first vehicle from the data collected by the first node and correlates the first vehicle using the magnetic signature to a predefined vehicle class, the predefined vehicle class grouping vehicles by structural similarity.

2. The automated computerized system of claim 1, wherein the first node is positioned adjacent to a road lane.

3. The automated computerized system of claim 1, wherein the first node is positioned in a center of a road lane.

4. The automated computerized system of claim 1, wherein the traffic monitoring software further reads:
data corresponding to arrival time and departure time of the first vehicle collected by the first node;
data corresponding to arrival time of the first vehicle collected by a second node, the second node longitudinally positioned from the first node and separated by a pre-determined distance;
wherein the traffic monitoring software executed by the computer system determines speed of the first vehicle based upon the unique magnetic signature of the first vehicle, at least one of the arrival time and the departure time collected by the first node, and the arrival time of the first vehicle collected by the second node.

5. The automated computerized system of claim 4, wherein the traffic monitoring software executed by the computer system determine vehicle magnetic length of the first vehicle using an instantaneous speed and occupancy time data of the first vehicle.

6. The automated computerized system of claim 5, wherein the traffic monitoring software executed by the computer system correlates the first vehicle into the predefined vehicle class using the vehicle magnetic length.

7. The automated computerized system of claim 4, wherein the traffic monitoring software executed by the computer system further reads data corresponding to arrival time and departure time of a plurality of vehicles collected by the first node and data corresponding to arrival time and departure time of the plurality of vehicles collected by the second node and determines average speed of the plurality of vehicles over a predefined time period.

8. The automated computerized system of claim 1, wherein the traffic monitoring software further reads:
data corresponding to magnetic field of the first vehicle collected by a second node;
wherein the traffic monitoring software executed by the computer system determines a unique magnetic signature for the first vehicle from the data collected by the second node and uses a vehicle re-identification process to match the magnetic signature from data collected by the first node to the magnetic signature from data collected by the second node.

9. One or more non-transitory computer readable medium storing a set of computer executable instructions for running on one or more computer systems that when executed cause the one or more computer systems to:
receive data from a first node, the first node having a plurality of sensors configured to detect signals and transmit the data to the computer system;
determine a unique magnetic signature of a first vehicle using the data received from the first node;
correlate the magnetic signature of the first vehicle to a predefined vehicle class, the predefined vehicle class grouping two or more vehicle structures.

10. The set of computer executable instruction of claim 9, further comprising receiving data from a second node, the second node positioned at a pre-determined distance from the first node; and determining speed of the first vehicle using data collected by the first and second nodes.

11. The set of computer executable instructions of claim 10, further comprising determining vehicle magnetic length of the first vehicle using the speed of the first vehicle and occupancy time data of the first vehicle.

12. The set of computer executable instructions of claim 9, further comprising receiving data from a plurality of nodes; identifying the unique magnetic signature of the first vehicle from data collected at each node; and determining at least one of first location or origin of the first vehicle based on identification of the unique magnetic signature at each node.

13. The set of computer executable instructions of claim 12, further comprising determining at least one of a second location or destination of the first vehicle based on identification of the unique magnetic signature at each node.

14. The set of computer executable instructions of claim 12, further comprising determining route of the first vehicle based on identification of the unique magnetic signature at each node.

15. The set of computer executable instructions of claim 9, further comprising receiving data from a plurality of nodes; identifying unique magnetic signatures for each of a plurality of vehicles from data collected at each node; determining routes for each of the plurality of vehicles from the unique magnetic signatures for each of the plurality of vehicles; and analyzing the routes for each of the plurality of vehicles to identify one or more traffic patterns.

16. An automated method of classifying a vehicle, comprising:
receiving data related to a first vehicle from a first node positioned on a roadway, the node collecting a plurality of signals from at least one sensor and transmitting the signal to a processor;
determining a unique magnetic signature of the first vehicle using the data collected from the at least one sensor;
correlating the first vehicle to a vehicle class using the unique magnetic signature of the first vehicle, the vehicle class grouping vehicles by structural similarity.

17. The automated method of claim 16, wherein at least a portion of the processor is within an intelligent access point (iAP).

18. The automated method of claim 16, wherein at least a portion of the processor is in an internet cloud computing center.

19. The automated method of claim 16, further comprising receiving data related to the first vehicle from a second node positioned on the roadway, and determining speed of the first vehicle based on the data collected from the first node and the second node.

20. The automated method of claim 19, further comprising determining vehicle magnetic length of the first vehicle using the speed, and at least one of the occupancy time data, determined using data transmitted from at least one of the first node and the second node and travel time determined using data transmitted from the first node and the second node.
